(19) United States
(12) Patent Application Publication
(10) Pub. No.: US 2023/0174729 A1
(43) Pub. Date: Jun. 8, 2023

(54) Water Soluble Films And Deep Drawn Articles Made From Same

(71) Applicant: MonoSol, LLC, Merrillville, IN (US)

(72) Inventors: Percy Bromby, II, Merrillville, IN (US); Dmitriy Davydovich, Merrillville, IN (US); Ramaswamy Ramaswamy, Merrillville, IN (US)

(21) Appl. No.: 18/063,054

(22) Filed: Dec. 7, 2022

Related U.S. Application Data
(60) Provisional application No. 63/286,943, filed on Dec. 7, 2021.

(51) Int. Cl. C08J 5/18; C08K 5/053

(52) U.S. Cl. CPC C08J 5/18; C08K 5/053; C08J 2329/04

(57) ABSTRACT

Thermoformed articles comprising a film thermoformed to be in the form of a pouch defining an interior pouch volume, the film comprising a mixture of a polyvinyl alcohol resin and a plasticizer, wherein the plasticizer is provided in an amount in a range of about 5 to about 30 weight parts, based on 100 weight parts of total polyvinyl alcohol resin; wherein the thermoformed film in the form of a pouch defining an interior pouch volume is characterized by a draw ratio in a range of about 2.3 to about 2.9; the article is characterized by a release time of at least 30 seconds when formed into a sealed packet and tested in accordance with the Liquid Release Test; and the article is characterized by a residue value of at most 9%, as determined by the Residue Test.

### FIELD OF THE INVENTION

The present disclosure relates generally to water soluble films and related articles. More particularly, the disclosure relates to water soluble films suitable for thermoforming deep-drawn profiles, and thermoformed articles comprising same, which when provided as a pouch or packet enclosing a liquid composition demonstrate desirable delayed liquid release from the pouch or packet and low residue values.

### BACKGROUND

Water soluble polymeric films are commonly used as packaging materials to simplify dispersing, pouring, dissolving and dosing of a material to be delivered. For example, pouches made from water soluble film are commonly used to package household care compositions such as laundry or dish detergent. A consumer can directly add the pouched composition to a mixing vessel, such as a bucket, sink or washing machine. Advantageously, this provides for accurate dosing while eliminating the need for the consumer to measure the composition. The pouched composition may also reduce mess that would be associated with dispensing a similar composition from a vessel, such as pouring a liquid laundry detergent from a bottle. In sum, soluble pre-measured polymeric film pouches provide for convenience of consumer use in a variety of applications.

Soluble unit doses (SUDS) can be designed to include multiple cavities, with each cavity having its own shape and size. Some commercial water soluble films demonstrate inadequate performance in more complicated unit dose designs, for example, in unit doses having deep box-like cavities. Additionally, some commercial water soluble films demonstrate excellent cold water solubility, but demonstrate inadequate performance in preventing premature release of liquid contents which is now required by some regulatory agencies to prevent immediate release of a liquid material if, for example, a child places a soluble unit dose in their mouth. Further, while some commercial water soluble films can demonstrate suitable delays in liquid release to meet the regulatory requirements, these films often display inadequate solubility, such that unacceptable film residue remains after the unit dose is used and releases its contents. Thus, there exists a need in the art for a water soluble film suitable for thermoforming deep-drawn profiles, e.g. for use in water soluble single dose packaging, that can be formed into packages for holding liquid detergents that when formed into packages will retain its liquid content for at least 30 seconds when the soluble packaging is placed in water at 20° C., while not leaving unacceptable levels of residue behind.

### SUMMARY

One aspect of the disclosure provides a thermoformed article comprising a film thermoformed to be in the form of a pouch defining an interior pouch volume, the film comprising a mixture of a polyvinyl alcohol resin and a plasticizer, wherein the plasticizer is provided in an amount in a range of about 5 to about 30 weight parts, based on 100 weight parts of total polyvinyl alcohol resin, wherein the thermoformed film in the form of a pouch defining the interior pouch volume is characterized by a draw ratio in a range of about 2.3 to about 2.9, the article characterized by a release time of at least 30 seconds when formed into a sealed packet and tested in accordance with the Liquid Release Test and by a residue value of at most 9%, as determined by the Residue Test.

Another aspect of the disclosure provides a unit dose article comprising a sealed compartment and a composition housed in the sealed compartment, wherein the unit dose article comprises (a) a first film thermoformed in the form of a pouch defining an interior pouch volume, the pouch having an opening; and (b) a second film sealed to the first film at the opening to create the sealed compartment, wherein the first film comprises a mixture of a polyvinyl alcohol resin and a plasticizer, wherein the plasticizer is provided in an amount in a range of about 5 to about 30 weight parts, based on 100 weight parts of total polyvinyl alcohol resin; and wherein the first film thermoformed in the form of a pouch defining an interior pouch volume is characterized by a draw ratio in a range of about 2.3 to about 2.9; the first film is characterized by a release time of at least 30 seconds when formed into a sealed packet and tested in accordance with the Liquid Release Test, and the first film is characterized by a residue value of at most 9%, as determined by the Residue Test.

Another aspect of the disclosure provides a method of improving the liquid release time of a thermoformed film, the method comprising contacting the thermoformed film having a draw ratio in a range of 2.3 to 3.1 with a liquid detergent or solvent for at least two days, wherein the film comprises a polyvinyl alcohol resin and a plasticizer, wherein the plasticizer is provided in an amount in a range of about 5 to about 30 weight parts, based on 100 weight parts of total polyvinyl alcohol resin (phr), wherein the liquid detergent or solvent comprises from about 10% to about 30% water, based on the total weight of the detergent or solvent.

For the compositions and methods described herein, optional features, including but not limited to components, compositional ranges thereof, substituents, conditions, and steps are contemplated to be selected from the various aspects, embodiments, and examples provided herein.

Further aspects and advantages will be apparent to those of ordinary skill in the art from a review of the following detailed description, taken in conjunction with the drawings. While the film, article, pouch, and their methods of making and use are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

For further facilitating the understanding of the present invention, four drawing figures are appended hereto.

FIG. 1 shows the dynamic mechanical analysis (DMA) thermograms for Film A according to the disclosure demonstrating the appearance of a secondary glass transition temperature upon thermoforming to a draw ratio of 2.6 or greater.

FIG. 2 shows DMA thermograms for Film B according to the disclosure demonstrating the appearance of a secondary glass transition temperature upon thermoforming to a draw ratio of 2.6 or greater.

FIG. 3 shows DMA thermograms for Film C not according to the disclosure demonstrating no appearance of a secondary glass transition temperature upon thermoforming to a draw ratio of 2.6 or greater.

FIG. 4A shows one set-up for the Liquid Release Test using a beaker and a plastic grid to facilitate keeping a buoyant pouch completely submerged in water.

FIG. 4B shows the set-up for the Liquid Release Test in use.

### DETAILED DESCRIPTION

One aspect of the disclosure provides a thermoformed article comprising a film thermoformed to be in the form of a pouch defining an interior pouch volume, the film comprising a mixture of a polyvinyl alcohol resin and a plasticizer, wherein the plasticizer is provided in an amount in a range of about 5 to about 25 weight parts, based on 100 weight parts of total polyvinyl alcohol resin, wherein the thermoformed film in the form of a pouch defining the interior pouch volume is characterized by a draw ratio in a range of about 2.3 to about 2.9, the article characterized by a release time of at least 30 seconds when formed into a sealed packet and tested in accordance with the Liquid Release Test and by a residue value of at most 9%, as determined by the Residue Test.

In general, thermoforming of a film results in thinning of a film as the film is drawn into a cavity or mold, relative to the thickness of the film prior to thermoforming. Thus, as the draw ratio of a film is increased, the thickness of the film is expected to decrease. Such thinning of a film is expected to result in faster release of a composition contained within the thermoformed film at given temperature, as there is less film material between the water and enclosed composition. Further, without intending to be bound by theory, it is believed that thermoforming promotes polymer chain alignment and introduces stress into the polymer matrix, which can result in a decrease in the disintegration time of the film, and decrease in the length of time the film will contain any enclosed composition once the film is contacted with water (i.e., demonstrate a decreased liquid release time) relative to the same film that has not been thermoformed. Advantageously, it was found that for the articles of the disclosure, prepared from thermoformed films including plasticizer in an amount of about 5 to about 25 phr, the stress from thermoforming can be relaxed by contacting the film with a liquid detergent composition or solvent comprising from about 10 to about 30 wt % water. Such stress relaxation of the polymer chains correlates to improved liquid release time, relative to films that have been thermoformed and are not contacted with such a liquid detergent or solvent, or relative to thermoformed films having a high initial (greater than 40 phr) plasticizer content. As used herein, “polyvinyl alcohol co-[monomer] polymer” encompasses partially hydrolyzed polyvinyl acetate copolymers (i.e., a terpolymer including vinyl acetate monomer units, vinyl alcohol monomer units, and the co-monomer (e.g., maleate) units), and fully hydrolyzed polyvinyl acetate copolymers (i.e., a true copolymer including vinyl alcohol monomer units and the co-monomer (e.g., maleate) units).

“Comprising” as used herein means that various components, ingredients or steps that can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. For example, a thermoformed packet can “consist essentially of” a film described herein for use of its thermoforming characteristics, while including a non-thermoformed film (e.g., lid portion), and optional markings on the film, e.g. by inkjet printing. The invention illustratively disclosed herein suitably may be practiced in the absence of any element or step which is not specifically disclosed herein.

Films, such as those made in accordance with the disclosure, are defined by the polymer industry (Encyclopedia of Polymer Science and Technology, John Wiley & Sons, Inc., 1967, Vol. 6, page 764) as “shaped plastics that are comparatively thin in relation to their breadth and width and have a maximum thickness of 0.010 in.”

Self-supporting films are those capable of supporting their own weight. Uniform films refer to those which are virtually free of breaks, tears, holes, bubbles, and striations.

To be considered a water-soluble film according to the present disclosure, the film, at a thickness of about 1.5 mil (about 0.038 mm), dissolves in 300 seconds or less in water at a temperature of 20° C. (68° F.) in accordance with MonoSol Test Method MSTM-205.

As used herein, the terms packet(s) and pouch(es) should be considered interchangeable. In certain embodiments, the terms packet(s) and pouch(es), respectively, are used to refer to a container made using the film and a sealed container preferably having a material sealed therein, e.g., in the form of a measured dose delivery system. The sealed pouches can be made from any suitable method, including such processes and features such as heat sealing, solvent welding, and adhesive sealing (e.g., with use of a water-soluble adhesive).

All percentages, parts and ratios are based upon the total dry weight of the formed film composition and all measurements are made at about 25° C., unless otherwise specified. All such weights as they pertain to listed ingredients are based on the active level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

The dimensions and values disclosed herein are not to be understood as being strictly limited to the exact numerical values recited. Instead, unless otherwise specified, each such dimension is intended to include both the recited value and a functionally equivalent range surrounding that value. For example, a dimension disclosed as “15 mm” is intended to include “about 15 mm,” and “about 15 mm” can include a range of from 14.5 mm to 15.4 mm, e.g. by numerical rounding.

As used herein and unless specified otherwise, the terms “wt. %” and “wt %” are intended to refer to the composition of the identified elements in “dry” (non water) parts by weight of the entire film (when applicable) or parts by weight of the entire composition enclosed within a pouch (when applicable). As used herein and unless specified otherwise, the term “PHR” is intended to refer to the composition of the identified element in parts per one hundred parts water soluble polymer (or resin; whether polyvinyl alcohol or otherwise) in the water soluble film.

As described below, the film described herein and pouches prepared therefrom, surprisingly provides one or more benefits, including but not limited to (a) excellent ability of the film to be converted into a deep drawn pouch or article having a draw ratio of at least about 2.6 using automated equipment (formability); (b) pouches having a passing grade when tested in accordance with the Liquid Release Test disclosed herein; and/or (c) a residue value of less than 9% when tested in accordance with the Residue Test disclosed herein; and/or (d) maintains transparency in a stretched state as demonstrated by a change in transmission of the stretched film relative to the film in an unstretched state of less than 5%. In embodiments, the film of the disclosure and pouches prepared therefrom demonstrate at least two benefits selected from (a), (b), (c), and (d) described above. In some embodiments, the film of the disclosure and pouches prepared therefrom demonstrate passing grades when tested in accordance with the Liquid Release Test (b) and at least one benefit selected from (a) and (c). In some embodiments, the film of the disclosure and pouches prepared therefrom demonstrate passing grades when tested in accordance with the Liquid Release Test (b) and excellent conversion to a deep drawn pouch (a). In some embodiments, the film of the disclosure and pouches prepared therefrom demonstrate passing grades when tested in accordance with the Liquid Release Test (b) and a residue value of less than 9% when tested in accordance with the Residue Test disclosed herein (c). In some embodiments, the film of the disclosure and pouches prepared therefrom demonstrate passing grades when tested in accordance with the Liquid Release Test (b) and maintain transparency in a stretched state (d). In embodiments, the film of the disclosure and pouches prepared therefrom demonstrate each of (a), (b), (c), and (d).

As used herein, unless specified otherwise, “deep-drawn” profiles refer to a profile having a draw ratio of at least 2.6. Good film formability can be determined by visual inspection wherein the film follows the form of the cavity smoothly and uniformly (e.g., walls, corners, and bottom of the cavity) and the thermoformed article regions (e.g., walls, corners, and bottom of a thermoformed shape) lack or minimization of defects (e.g. lack of folding or creasing in what is intended to be a smooth surface in the thermoformed shape). In embodiments, “deep-drawn” profiles refer to a profile having a draw ratio of at least 2.9.

The film can be made by a solution casting method. The film can be used to form an article or a pouch by any suitable process, including thermoforming and, for example, solvent sealing or heat sealing of film layers around a periphery of the article. The pouches can be used for dosing materials to be delivered into bulk water, for example.

The films, articles, pouches, and related methods of making and use are contemplated to include embodiments including any combination of one or more of the elements, features, and steps further described below (including those shown in the Examples and figures), unless stated otherwise.

Water Soluble Films

Unit dose design, including the number of cavities and the shape and size of the cavities, can be used to differentiate and gain advantage over commercial single use dosages (SUDS). The formability of the film used to prepare SUDS becomes more important as the depth of the cavity increases, the number of cavities increases, and the shape of the cavities becomes more box-like and less oval. The films of the disclosure can be designed to perform in complicated unit dose designs and have one or more advantages such as formability into deep-drawn profiles and/or box-like profiles. The film and related articles and pouches described herein can comprise a plasticized, solution-cast, water soluble film. The films optionally further include one or more additives selected from fillers, surfactants, anti-block agents, antioxidants, antifoams, bleaching agents, aversive agents, pungents, other functional ingredients, and combinations of the foregoing. In one aspect, the water soluble film can comprise a total of at least about 50 wt % of a PVOH resin comprising one or more PVOH polymers.

Without intending to be bound by theory, it is believed that a moderately-low viscosity resin, as described below, allows for easier flow of the polymer molecules at thermoforming temperatures and faster solubility at lower temperatures (e.g. 12 cP to 28 cP, or about 14 cP to about 26 cP, or about 18 cP to about 24 cP). However, the viscosity of the resin should not be so low that there is insufficient viscosity to create physically strong and robust soluble unit doses.

The film can have any suitable thickness, and film thicknesses of about 76 microns (μm) or 88 microns are typical and particularly contemplated. Other values and ranges contemplated include values in a range of about 5 to about 200 μm, or in a range of about 20 to about 100 μm, or about 60 to about 120 μm, or about 70 to about 100 μm, or about 40 to about 90 μm, or about 50 to about 80 μm, or about 60 to about 65 μm for example 65 μm, 76 μm, 88 μm, or 90 μm.

### PVOH Resins

The film described herein includes one or more polyvinyl alcohol (PVOH) polymers to make up the PVOH resin content of the film, and can include a PVOH copolymer resin.

Polyvinyl alcohol is a synthetic resin generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water-greater than about 140° F. (about 60° C.). If a sufficient number of acetate groups are allowed to remain after the hydrolysis of polyvinyl acetate, that is, the PVOH polymer is partially hydrolyzed, then the polymer is more weakly hydrogen-bonded, less crystalline, and is generally soluble in cold water—less than about 50° F. (about 10° C.). As such, the partially hydrolyzed polymer is a vinyl alcohol-vinyl acetate copolymer that is a PVOH copolymer, but is commonly referred to as homopolymer PVOH.

In particular, the PVOH resin can include a partially or fully hydrolyzed PVOH copolymer that includes an anionic monomer unit, a vinyl alcohol monomer unit, and optionally a vinyl acetate monomer unit. In various embodiments, the anionic monomer unit can be one or more of vinyl acetic acid, alkyl acrylates, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, itaconic acid, monomethyl itaconate, dimethyl itaconate, itaconic anhydride, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, vinyl sulfonic acid, alkyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C₁-C₄ or C₆ alkyl esters), and combinations of the foregoing (e.g., multiple types of anionic monomers or equivalent forms of the same anionic monomer). For example, the anionic monomer can include one or more of monomethyl maleate and alkali metal salts thereof (e.g. sodium salts).

In one type of embodiment, the PVOH is a carboxyl group modified copolymer. In another aspect, the PVOH can be modified with a dicarboxyl type monomer. In one class of these embodiments, the α carbon of the carbonyl is contacted to the unsaturated bond (e.g., maleic acid, fumaric acid). In another class of these embodiments, the a carbon of the carbonyl is contacted to the unsaturated bond with a methyl branch (e.g., citraconic acid, mesaconic acid). In another class of these embodiments, the β carbon of the carbonyl is contacted to the unsaturated bond (e.g., itaconic acid, cis-glutaconic acid, trans-glutaconic acid). Monomers that provide alkyl carboxyl groups are contemplated. A maleate type (e.g., dialkyl maleate, including monomethyl maleate) or itaconate type (i.e., itaconic acid) comonomer is particularly contemplated.

In certain carboxylate-containing PVOH copolymers, the carboxylate units, if converted to carboxylic acid groups, are readily able to form stable gamma-lactone ring moieties by cyclizing with adjacent hydroxyl groups. Specifically, such gamma-lactone ring formation occurs when the carboxylate-containing PVOH copolymers are in contact with liquid laundry detergent formulations. The chemical incompatibility derives from the acid-base equilibria that exist in the liquid laundry detergent formulations and are usually in the form of amine-fatty acid equilibria and/or amine-anionic surfactant acid equilibria. Even if the detergent formulation is at an alkaline pH by virtue of the presence of a molar excess of amine, exchangeable hydrogen ions are still available to react with the carboxylate groups of the PVOH copolymer. When this happens, carboxylic acid groups form and they in turn will readily react with adjacent hydroxyl groups to form intramolecular lactones if the lactones have stable five-membered (gamma) ring structures. Other liquid products too numerous to mention may present similar chemical incompatibilities. The solubility of the polymer and hence the film is markedly affected by this reaction to form lactones; complete insolubility can occur in some cases resulting in polymer residues being attached to objects dispersed in a liquid with the polymer/film (e.g., on items of clothing at the end of a wash cycle with a detergent pouch made of such film). In contrast, other carboxylate-containing PVOH copolymers may potentially form lactone ring moieties smaller than five-membered or larger than five-membered; however, these lactone moieties are unstable due to steric and/or entropic effects and, therefore, such copolymers do not demonstrate the same change in solubility in the presence of a laundry detergent as the carboxylate-containing PVOH copolymers that can form gamma-lactone ring moieties.

In embodiments, the polyvinyl alcohol resin comprises a polyvinyl alcohol-co-maleate polymer. In refinements of the foregoing embodiments, the polyvinyl alcohol-co-maleate polymer may include one or more monomer units selected from maleic acid, monoalkyl maleate, dialkyl maleate, maleic anhydride, and alkali metal salts thereof. The polyvinyl alcohol-co-maleate polymer may be a partially or fully hydrolyzed copolymer of polyvinyl acetate and maleic anhydride. In embodiments, the polyvinyl alcohol-co-maleate includes at least 1 mol % maleate modification and up to about 8 mol % maleate modification, for example, about 1.5 mol %, about 1.75 mol %, about 2 mol %, about 2.4 mol %, about 2.5 mol %, about 2.8 mol %, about 3 mol %, about 3.2 mol %, about 3.5 mol %, about 3.8 mol %, about 4 mol %, about 4.2 mol %, about 4.5 mol %, about 5 mol %, about 6 mol %, about 7 mol %, or about 8 mol %.

In embodiments when the polyvinyl alcohol resin comprises a blend of polyvinyl alcohol polymers or copolymers, at least one of the polyvinyl alcohol polymers may comprise a first polyvinyl alcohol-co-maleate polymer. In embodiments, the blend of polyvinyl alcohol polymers may further include second polyvinyl alcohol-co-maleate polymer. The first and second polyvinyl alcohol-co-maleate polymers can differ in viscosity, degree of modification, degree of hydrolysis, or a combination of the foregoing. In embodiments, the first polyvinyl alcohol-co-maleate polymer comprises a maleate monomer unit derived from a member selected from the group of maleic acid, monoalkyl maleate, dialkyl maleate, maleic anhydride, and a combination thereof. In embodiments, the second polyvinyl alcohol-co-maleate polymer comprises a maleate monomer unit derived from a member selected from the group of maleic acid, monoalkyl maleate, dialkyl maleate, maleic anhydride, and a combination thereof. As used herein, and unless specified otherwise, a polymer monomer unit is “derived from” a monomer insofar as the monomer has undergone polymerization and is now provided in the polymer.

In embodiments, the first polyvinyl alcohol-co-maleate polymer can include about 1 mol % to about 3 mol % maleate modification, based on the total moles of monomer units. In embodiments, the second polyvinyl alcohol-co-maleate polymer can include about 3 mol % to about 5 mol % maleate modification, based on the total moles of monomer units. In embodiments, the first polyvinyl alcohol-co-maleate polymer can include about 1 to less than 3 mol % maleate modification and the second polyvinyl alcohol-co-maleate polymer can include greater than 3 mol % and up to about 5 mol % maleate modification, based on the total moles of monomer units. In embodiments wherein the polyvinyl alcohol resin comprises a blend of PVOH polymers including polyvinyl alcohol-co-maleate copolymers, the PVOH resin blend may have an arithmetic weighted average amount of maleate groups of at least about 2 mol % maleate modification and up to about 8 mol % maleate modification, for example, about 2.1 mol %, about 2.2 mol %, about 2.3 mol %, about 2.5 mol %, about 2.6 mol %, about 2.7 mol %, about 3 mol %, about 3.2 mol %, about 3.5 mol %, about 3.8 mol %, about 4 mol %, about 4.5 mol %, about 5 mol %, about 6 mol %, about 7 mol %, or about 8 mol %. The arithmetic weighted average of the modification m̅ is calculated by the formula m̅=Σ(Wᵢ·mᵢ) wherein Wᵢ is the weight percentage of the respective PVOH copolymer and mᵢ is the respective mol % of modification in the PVOH copolymer.

Without intending to be bound by theory, it is believed a film comprising two polyvinyl alcohol-co-maleate polymers that differ in viscosity, degree of modification, degree of hydrolysis, or a combination thereof can be less susceptible to formation of ordered domains within the film upon thermoforming compared to a film comprising only one type of polyvinyl alcohol polymer, leading to improved liquid release time due to reduced stress in the thermoformed film.

The amount of PVOH resin in the film can be in a range of about 55 to about 95% by weight based on the total weight of the film, or about 60% to 90%, or about 65% to about 85%, for example. In embodiments including a blend of PVOH polymers, the first polyvinyl alcohol-co-maleate polymer can be provided in an amount in a range of about 50 wt. % to about 90 wt. %, for example, about 60 wt. % to about 80 wt. %, or about 70 wt. %, based on the total weight of the polyvinyl alcohol polymers. In embodiments including a blend of PVOH polymers, the second polyvinyl alcohol-co-maleate polymer can be provided in an amount in a range of about 10 wt. % to about 50 wt. %, for example, about 20 wt. % to about 40 wt. %, or about 30 wt. %, based on the total weight of the polyvinyl alcohol polymers. In embodiments, the PVOH resin consists of the first polyvinyl alcohol-co-maleate polymer and the second polyvinyl alcohol-co-maleate polymer, and the first polyvinyl alcohol-co-maleate polymer is provided in an amount in a range of about 50 wt. % to about 90 wt. %, about 55 wt. % to about 85 wt. %, about 60 wt. % to about 80 wt. %, about 65 wt. %, to about 75 wt. %, or about 70 wt. %, based on the total weight of the PVOH polymers, with the balance being made up from the second polyvinyl alcohol-co-maleate polymer.

The total PVOH resin content of the film can have a degree of hydrolysis (D.H. or DH) of at least 80%, 84%, or 85% and at most about 99.7%, 98%, or 96%, for example in a range of about 84% to about 90%, or 85% to 88%, or 86.5%, or in a range of 88% to 95%, about 89% to 93%, or 89.5% to 92%, for example, about 89%, about 90%, about 92%, about 93%, about 94%, about 95%, or about 96%. As used herein, the degree of hydrolysis is expressed as a mole percentage of vinyl acetate units converted to vinyl alcohol units.

The degree of hydrolysis of a resin blend can also be characterized by the arithmetic weighted, average degree of hydrolysis)(H̅°̅). For example, H̅°̅ for a PVOH resin that comprises two or more PVOH polymers is calculated by the formula H̅°̅=Σ(Wᵢ·Hᵢ) where Wᵢ is the weight percentage of the respective PVOH polymer and Hᵢ is the respective degrees of hydrolysis.

The viscosity of a PVOH polymer (μ) is determined by measuring a freshly made solution using a Brookfield LV type viscometer with UL adapter as described in British Standard ENISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

Without intending to be bound by theory, it is believed that lower viscosity (molecular weight) of the PVOH allows easier molecular movement at high temperatures and therefore easier flow of the film in deep cavities. Without intending to be bound by theory, it is believed that the lower viscosity of the PVOH resins allows for greater chain mobility at any given temperature; upon cooling and stress relaxation after the thermoforming step the lower molecular weight PVOH polymer can more easily move into a preferred conformation of packing and hydrogen bonding resulting in a higher mechanical strength. It is recognized that this trend cannot continue to “zero” viscosity and therefore the PVOH resin, or combination of one or more PVOH resins, provided in the water soluble film can have a mean viscosity of at least about 14 cP, or least about 16 cP, or least about 17 cP, or least about 18 cP, or least about 19 CP, or least about 20 cP and at most about 26 cP, or at most about 24 cP, or at most about 23 cP, or at most about 22 cP, or at most about 21 cP, or at most about 20 cP, for example in a range of about 12 cP to 28 cP, or about 14 cP to about 26 cP, or about 18 cP to about 24 cP. If the PVOH resin part of the film is a combination of one or more resins, then the combination can have a mean viscosity corresponding to the values and ranges just described, e.g. by weight averaging of the individual component viscosity values. In another type of embodiment, the combination of PVOH resins (in their intended ratios) can be made up as a 4% aqueous solution and have its viscosity measured. Suitable PVOH resins, for use individually or in combinations, can have viscosities in a range of about 10 cP to about 40 cP, or about 5 cP to about 38 cP, or about 10 cP to about 36 cP, or about 10 cP to about 20 cP, or about 12 cP to about 20 cP, or about 14 cP to about 19 cP, or about 12 cP to about 34 cP, or about 14 cP to about 32 cP, or about 18 cP to about 30 cP, about 20 cP to about 28 cP, about 21 cP to about 26 cP, for example 32 cP, or 26 cP, or 23.5 cP, or 21 cP, or 19 cP, or 16.5 cP, or 14 cP. It is well known in the art that the viscosity of PVOH resins is correlated with the weight average molecular weight (M̅w) of the PVOH resin, and often the viscosity is used as a proxy for the M̅w. When referring to the viscosity of a PVOH resin comprising a PVOH polymer blend, the weighted natural log average viscosity (μ̅) is used. The μ̅ for a PVOH resin that comprises two or more PVOH polymers is calculated by the formula μ̅=e^{ΣW}^{ᵢ}^{·lnμ}^{ᵢ} where μᵢ is the viscosity for the respective PVOH polymers.

In embodiments comprising a blend of PVOH polymers including the first PVOH-co-maleate polymer and the second PVOH-co-maleate polymer, the first PVOH-co-maleate polymer can have a viscosity in a range of about 18 to about 30 cP, for example, about 19 to about 28 cP, about 20 to about 26 cP, or about 21 to about 26 cP. In embodiments comprising a blend of PVOH polymers including the first PVOH-co-maleate polymer and the second PVOH-co-maleate polymer, the second PVOH-co-maleate polymer can have a viscosity in a range of about 10 to about 20 cP, for example, about 12 to about 19 cP, or about 14 to about 19 cP.

Other water soluble polymers for use in addition to the PVOH copolymer in the film can include, but are not limited to a vinyl alcohol-vinyl acetate copolymer, sometimes referred to as a PVOH homopolymer, polyacrylates, water soluble acrylate copolymers, polyvinyl pyrrolidone, polyethyleneimine, pullulan, water soluble natural polymers including, but not limited to, guar gum, gum Acacia, xanthan gum, carrageenan, pectin, amylopectin, alginic acid and salts thereof, and starch, water soluble polymer derivatives including, but not limited to, modified starches, ethoxylated starch, and hydroxypropylated starch, copolymers of the forgoing and combinations of any of the foregoing. Yet other water soluble polymers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, and combinations of any of the foregoing. In embodiments, the film can include a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing Such water soluble polymers, whether PVOH or otherwise, are commercially available from a variety of sources.

### Plasticizers

A plasticizer is a liquid, solid, or semi-solid that is added to a material (usually a resin or elastomer) making that material softer, more flexible (by decreasing the glass-transition temperature of the polymer), and easier to process. At low plasticizer levels, films may become brittle, difficult to process, or prone to breaking. At elevated plasticizer levels, films may be too soft, weak, or difficult to process for a desired use. Water is recognized as a very efficient plasticizer for PVOH and other polymers; including but not limited to water soluble polymers, however, the volatility of water makes its utility limited as polymer films need to have at least some resistance (robustness) to a variety of ambient conditions including low and high relative humidity.

The plasticizer can include, but is not limited to, glycerol, diglycerol, sorbitol, ethylene glycol, diethylene glycol, triethylene glycol, dipropylene glycol (DPG), tetraethylene glycol, propylene glycol, polyethylene glycols up to 400 MW, neopentyl glycol, trimethylolpropane (TMP), polyether polyols, 2-methyl-1,3-propanediol (e.g. MP Diol®), ethanolamines, and mixtures thereof. In some embodiments, the plasticizer is selected from glycerol, diglycerol, propylene glycol, ethylene glycol, diethylene glycol, dipropylene glycol, polyethylene glycols up to MW 400 (e.g., PEG200), sorbitol, 2-methyl-1,3-propanediol, trimethylolpropane, polyether polyols, and combinations of the foregoing. In one type of embodiment, the plasticizer is selected from the group of sorbitol, glycerol, propylene glycol, 2-methyl-1,3-propanediol, trimethylolpropane, dipropylene glycol, and a combination thereof. In one type of embodiment, the plasticizer is selected from glycerol, propylene glycol, sorbitol, 2-methyl-1,3-propanediol and combinations of the foregoing. In another type of embodiment, the plasticizer includes glycerol, sorbitol, or a combination of the foregoing.

The total amount of the non-water plasticizer can be in a range of about 5 to about 30 weight parts per one hundred parts PVOH resin (PHR), or about 5 to about 25 PHR, or about 10 to about 25 PHR, or about 15 to about 24 PHR, or about 18 to about 23 PHR, for example, about 18 PHR, about 20 PHR, about 21 PHR, about 22 PHR, about 23 PHR, or about 24 PHR.

### Auxiliary Film Ingredients

The water soluble film can contain other auxiliary agents and processing agents, such as, but not limited to, surfactants, lubricants, release agents, fillers, extenders, cross-linking agents, antiblocking agents, antioxidants, detackifying agents, antifoams (defoamers), nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. In embodiments, the water soluble film can include a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.

Suitable surfactants can include the nonionic, cationic, anionic and zwitterionic classes. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Other suitable surfactants include dioctyl sodium sulfosuccinate, lactylated fatty acid esters of glycerol and propylene glycol, lactylic esters of fatty acids, sodium alkyl sulfates, polysorbate 20, polysorbate 60, polysorbate 65, polysorbate 80, lecithin, acetylated fatty acid esters of glycerol and propylene glycol, and acetylated esters of fatty acids, and combinations thereof. In various embodiments, the amount of surfactant in the water soluble film can be in a range of about 0.1 wt % to 4.0 wt %, or about 1.0 wt % to 3.0 wt %, or about 1.5 wt % to about 2.5 wt %, or about 0.1 PHR to about 9 PHR, or about 0.1 to about 8 PHR, or about 0.1 to about 6 PHR, or about 0.5 PHR to about 2.9 PHR, or about 0.5 PHR to about 1.5 PHR, or about 1 PHR to about 6 PHR, or about 1.5 PHR to about 5 PHR, or about 2 PHR to about 4 PHR, for example.

Suitable fillers/extenders/antiblocking agents/detackifying agents include, but are not limited to, starches, modified starches, crosslinked polyvinylpyrrolidone, crosslinked cellulose, microcrystalline cellulose, silica, metallic oxides, calcium carbonate, talc, mica, stearic acid and metal salts thereof, for example, magnesium stearate. Preferred materials are starches, modified starches and silica. In one type of embodiment, the amount of filler/extender/antiblocking agent/detackifying agent in the water soluble film can be in a range of about 1 wt % to about 6 wt %, or about 1 wt. % to about 4 wt. %, or about 2 wt. % to about 4 wt. %, or about 1 PHR to about 6 PHR, or about 1 PHR to about 4 PHR, or about 2 PHR to about 4 PHR, for example. In some embodiments, the films can be substantially free of silica. As used herein, and unless stated otherwise, “substantially free of silica” refers to films having silica present in an amount of less than about 500 ppm. For example, less than about 400 ppm, less than about 300 ppm, less than about 200 ppm, or less than about 100 ppm.

An anti-block agent (e.g., stearic acid)), when present in the film, can be present in the film in an amount of at least 0.1 PHR, or at least 0.5 PHR, or at least 1 PHR, or in a range of about 0.1 to 5.0 PHR, or about 0.1 to about 3.0 PHR, or about 0.4 to 1.0 PHR, or about 0.5 to about 0.9 PHR, or about 0.5 to about 2 PHR, or about 0.5 to about 1.5 PHR, or 0.1 to 1.2 PHR, or 0.1 to 2.7 PHR, for example 0.5 PHR, 0.6 PHR, 0.7 PHR, 0.8 PHR, or 0.9 PHR.

The water-soluble films of the disclosure can be obtained by casting, blow-moulding, extrusion, or blown extrusion of the mixture of the polyvinyl alcohol, plasticizer, and any optional secondary or auxiliary additives. Processes for solvent casting of PVOH are well-known in the art. For example, in the film-forming process, the polyvinyl alcohol resin(s) and secondary additives are dissolved in a solvent, typically water, metered onto a surface, allowed to substantially dry (or force-dried) to form a cast film, and then the resulting cast film is removed from the casting surface. The process can be performed batch wise, and is more efficiently performed in a continuous process.

In the formation of continuous films of polyvinyl alcohol, it is the conventional practice to meter a solution of the solution onto a moving casting surface, for example, a continuously moving metal drum or belt, causing the solvent to be substantially removed from the liquid, whereby a self-supporting cast film is formed, and then stripping the resulting cast film from the casting surface.

Optionally, the water soluble film can be a free-standing film consisting of one layer or a plurality of like layers.

### Thermoformed Articles

The disclosure provides a water-soluble unit dose article. The water-soluble unit dose article comprises at least a first thermoformed compartment and optionally a composition housed in the compartment. Suitable compositions are described in more detail below. The final water-soluble unit dose articles comprise water-soluble film thermoformed (shaped) such that the unit-dose article comprises at least one internal compartment surrounded by the water-soluble film. An intermediate construct contemplated as an aspect of the disclosure herein can include elements of the article or portions of the article in an unsealed state, e.g., to allow for provision of a composition into the intermediate construction prior to final filling. The water-soluble unit dose article is constructed such that the composition does not leak out of the compartment during storage. However, upon contact of the water-soluble unit dose article with water, the water-soluble film dissolves and releases the contents of the internal compartment, e.g., into a wash liquor, bulk water, or other environment (e.g., onto soil in the case of an agricultural composition).

A compartment of the final unit dose article should be understood as meaning a closed internal space within the unit dose article, which holds the composition when present. In practice, a compartment can be devoid of a composition, or devoid of a solid or liquid type composition disposed therein, e.g., containing only air to provide an article which has a degree of buoyancy for a period of time prior to dissolution.

Thermoforming a film is the process of heating the film, shaping it (e.g. in a mold), and then allowing the film to cool, whereupon the film will hold its shape, e.g. the shape of the mold. The heat may be applied using any suitable means. For example, the film may be heated directly by passing it under a heating element or through hot air, prior to feeding it onto a surface or once on a surface. Alternatively, it may be heated indirectly, for example by heating the surface or applying a hot item onto the film. In some embodiments, the film is heated using an infrared light. The film may be heated to a temperature in a range of about 50 to about 150° C., about 50 to about 120° C., about 60 to about 130° C., about 70 to about 120° C., or about 80 to about 100° C. The water soluble film prior to thermoforming can have a thickness in a range of about 5 to about 200 μm, or in a range of about 20 to about 100 μm, or about 60 to about 120 μm, or about 70 to about 100 μm, or about 40 to about 90 μm, or about 50 to about 80 μm, or about 60 to about 65 μm for example 65 μm, 76 μm, 88 μm, or 90 μm.

Thermoforming can be performed by any suitable process, including vacuum thermoforming (by cavity or with a positive mold), pressure thermoforming (e.g. positive gas pressure, optionally with vacuum assist), and mechanical thermoforming (e.g. draped over a positive mold, and optionally with vacuum assist). In one type of embodiment, the thermoforming is vacuum thermoforming. In another type of embodiment, the vacuum thermoforming is by use of a cavity mold. The cavity mold can have a single cavity or can include two or more cavities. The vacuum drawing the film into the mold can be applied for about 0.2 to about 5 seconds, or about 0.3 to about 4, or about 0.5 to about 3 seconds, once the film is on the horizontal portion of the surface. This vacuum can be such that it provides an under-pressure in a range of 10 mbar to 1000 mbar, or in a range of 100 mbar to 600 mbar, for example.

The molds, in which articles may be made, can have any shape, length, width and depth, depending on the required dimensions. The molds may also vary in size and shape from one to another, if desirable. For example, the volume of the final articles may be about 5 ml to about 300 ml, or about 10 to 150 ml, or about 20 to about 100 ml, and that the mold sizes are adjusted accordingly. In some embodiments, the mold size can be selected such that the final articles have a volume of 25 mL or less, or 20 mL or less, or 15 mL or less, or 10 mL or less, or 5 mL or less, for example, in a range of about 5 mL to about 50 mL, or about 5 mL to about 30 mL.

In the alternative or in addition, the film can be wetted by any suitable means, for example directly by spraying a wetting agent (including water, a solution of the film composition, a plasticizer for the film composition, or any combination of the foregoing) onto the film, prior to feeding it onto the surface or once on the surface, or indirectly by wetting the surface or by applying a wet item onto the film.

Once a film has been heated and/or wetted in a first orientation at the top of the mold, it may be drawn into an appropriate mold into a second orientation, preferably using a vacuum.

The distance in the z-direction traveled by the film from the first orientation to the second orientation is the depth of draw. The filling of the molded film can be accomplished by utilizing any suitable means. In some embodiments, the most preferred method will depend on the product form and required speed of filling. In some embodiments, the molded film is filled, with a product to be contained in a resulting pouch, by in-line filling techniques. The filled, open packets are then closed forming the pouches, using a second film, by any suitable method. This may be accomplished while in horizontal position and in continuous, constant motion. The closing may be accomplished by continuously feeding a second film (same or different as the thermoformed film), preferably water-soluble film, over and onto the open packets and then preferably sealing the first and second film together, typically in the area between the molds and thus between the packets.

Any suitable method of sealing the packet and/or the individual compartments thereof may be utilized. Non-limiting examples of such means include heat sealing, solvent welding, solvent or wet sealing, and combinations thereof. Typically, only the area which is to form the seal is treated with heat or solvent. The heat or solvent can be applied by any method, typically on the closing material, and typically only on the areas which are to form the seal. If solvent or wet sealing or welding is used, it may be preferred that heat is also applied. Preferred wet or solvent sealing/welding methods include selectively applying solvent onto the area between the molds, or on the closing material, by for example, spraying or printing this onto these areas, and then applying pressure onto these areas, to form the seal. Sealing rolls and belts as described above (optionally also providing heat) can be used, for example.

In some embodiments, a thermoformed article comprising the water soluble film of the disclosure, wherein the film has an initial thickness in a range of 75-90 μm, can be characterized by a depth of draw (the distance in the z-direction traveled by the film from the first orientation to the second orientation during the thermoforming step) of at least 15 mm, or at least 20 mm, or at least 25 mm. In some embodiments, a thermoformed article according to the disclosure comprises a thermoformed cavity comprising walls, corners, and a bottom and can be characterized by a depth of draw of at least 25 mm.

In some embodiments, a thermoformed article comprising the water soluble film of the disclosure can be characterized by a draw ratio of at least 2.5, or at least 2.6, or at least 2.7, or at least 2.8, or at least 2.9, or at least 3.0, or at least 2.7, or at least 3.5, or at least 4.0. The draw ratio is the ratio of the area of the mold surface to the area of the film prior to drawing. In some embodiments, a thermoformed article according to the disclosure comprises a thermoformed cavity comprising walls, corners, and a bottom, and can be characterized by a draw ratio of at least 2.6. In some embodiments, a thermoformed article according to the disclosure comprises a thermoformed cavity comprising walls, corners, and a bottom and can be characterized by a draw ratio of at least 3.0. In some embodiments, a thermoformed article according to the disclosure comprises a thermoformed cavity comprising walls, corners, and a bottom and can be characterized by draw ratio of at least 3.6. The draw ratio in relation to the original film thickness is another parameter which describes the extent to which a film becomes thinner, e.g. from the perspective that a thicker film may tolerate higher draw ratios. In some embodiments, a thermoformed article comprising the water soluble film of the disclosure can be characterized by the ratio of the initial film thickness to the depth of draw ratio, e.g. by the depth of draw ratios and film thicknesses described herein and in the examples.

The unit dose articles of the disclosure can include a sealed compartment and a composition housed in the sealed compartment, wherein the unit dose article comprises (a) a first film thermoformed in the form of a pouch defining an interior pouch volume, the pouch having an opening; and (b) a second film sealed to the first film at the opening to create the sealed compartment, wherein the first film and second film are selected from any water soluble film disclosed herein, the first film is thermoformed in the form of a pouch defining an interior pouch volume is characterized by a draw ratio in a range of about 2.3 to about 2.9; the first film is characterized by a release time of at least 30 seconds when formed into a sealed packet and tested in accordance with the Liquid Release Test, and the first film is characterized by a residue value of at most 9%, as determined by the Residue Test. In embodiments, the first film comprises a mixture of a polyvinyl alcohol resin and a plasticizer, wherein the plasticizer is provided in an amount in a range of about 5 to about 30 weight parts, based on 100 weight parts of total polyvinyl alcohol resin. In embodiments, the first film and the second film are the same. In embodiments, the first film and the second film are the same except the second film is not thermoformed. In embodiments the first film and the second film are different and differ in type of resin (e.g., modified or unmodified polyvinyl alcohol, different viscosity PVOH, different degree of hydrolysis, and the like), amount of resin, type of plasticizer, amount of plasticizer, and/or type and amount of processing aids.

In embodiments, the film comprises about 70 parts of a first polyvinyl alcohol-co-maleate copolymer, about 30 parts of a second polyvinyl alcohol-co-maleate copolymer, and about 20 to 25 parts of plasticizer per 100 parts of polyvinyl alcohol polymer, and the film when thermoformed to a draw ratio of 2.9 has a passing grade when evaluated by the Liquid Release Test after contact with a liquid laundry detergent for one day, or for 7 days, or for 14 days. In embodiments, the film comprises about 70 parts of a first polyvinyl alcohol-co-maleate copolymer, about 30 parts of a second polyvinyl alcohol-co-maleate copolymer, and about 20 to 25 parts of plasticizer per 100 parts of polyvinyl alcohol polymer, and the film when thermoformed to a draw ratio of 3.1 has a passing grade when evaluated by the Liquid Release Test after contact with a liquid laundry detergent for 7 days, or for 14 days. In embodiments, the film comprises about 70 parts of a first polyvinyl alcohol-co-maleate copolymer, about 30 parts of a second polyvinyl alcohol-co-maleate copolymer, and about 40 to 45 parts of plasticizer per 100 parts of polyvinyl alcohol, and the film when thermoformed to a draw ratio of 2.9 has a passing grade when evaluated by the Liquid Release Test after contact with a liquid laundry detergent for one day, or for 7 days, or for 14 days.

The thermoformed shape (e.g., as dictated by a mold) can, in addition or in the alternative, be characterized by how box-like it is (e.g., compared to a more rounded shape). The boxiness of a mold and resulting thermoformed cavity is dictated by the radius of curvature provided at the intersection of walls, e.g. between individual side walls and between side walls and bottom of a cavity. Thus, in one aspect, the mold can be characterized by having a radius of curvature at any intersection (i.e. a minimum radius of curvature for the mold as a whole) of 10 mm or less, to be considered a more box-like profile. In other embodiments, the radius is 8 mm or less, or in a range of 0.1 mm to 5 mm for example.

The film is useful for creating an article and/or pouch to contain, for example, a detergent composition. The cleaning actives may take any form such as powders, gels, pastes, liquids, tablets or any combination thereof. The film is also useful for any other application in which improved wet handling and low cold water residues are desired. The film forms at least one side wall of the article and/or pouch, optionally the entire article and/or pouch, and preferably an outer surface of the at least one sidewall.

The film described herein can also be used to make an article and/or pouch with two or more compartments made of the same film or in combination with films of other polymeric materials. Additional films can, for example, be obtained by casting, blow-molding, extrusion or blown extrusion of the same or a different polymeric material, as known in the art. In one type of embodiment, the polymers, copolymers or derivatives thereof suitable for use as the additional film are selected from polyvinyl alcohols, polyvinyl pyrrolidone, polyalkylene oxides, polyacrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan, and carrageenans. For example, polymers can be selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and combinations thereof, or selected from polyvinyl alcohols, polyvinyl alcohol copolymers and hydroxypropyl methyl cellulose (HPMC), and combinations thereof. One contemplated class of embodiments is characterized by the level of polymer in the packet material, for example the PVOH copolymer described above, as described above, being at least 60%.

The articles and/or pouches of the present disclosure can include at least one sealed compartment. Thus, the articles and/or pouches may comprise a single compartment or multiple compartments. A water-soluble pouch or sachet can be formed from two layers of water-soluble polymer film sealed at an interface, or by a single film that is folded upon itself and sealed. One or both of the films include the PVOH film described above. The films define an interior article and/or pouch container volume which contains any desired composition for release into an aqueous environment.

The pouch container volume is not particularly limiting. The pouch container volume, in one type of embodiment is 25 mL or less. In another embodiment, the volume is less than 25 mL. The pouch container volume, in another type, is less than 50 mL.

The composition for use in the pouch is not particularly limited. In embodiments comprising multiple compartments, each compartment may contain identical and/or different compositions. In turn, the compositions may take any suitable form including, but not limited to liquid, solid and combinations thereof (e.g. a solid suspended in a liquid). In some embodiments, the pouches comprise a first, second and third compartment, each of which respectively contains a different first, second, and third composition. Liquid detergents are particularly contemplated.

The compartments of multi-compartment articles and/or pouches may be of the same or different size(s) and/or volume(s). The compartments of the present multi-compartment articles and/or pouches can be separate or conjoined in any suitable manner. In some embodiments, the second and/or third and/or subsequent compartments are superimposed on the first compartment. In one embodiment, the third compartment may be superimposed on the second compartment, which is in turn superimposed on the first compartment in a sandwich configuration. Alternatively, the second and third compartments may be superimposed on the first compartment. However, it is also equally envisaged that the first, second and optionally third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment. In some embodiments, the first compartment may be surrounded by at least the second compartment, for example in a tire-and-rim configuration, or in a pouch-in-a-pouch configuration.

The articles and/or pouches of the present disclosure may comprise one or more different films. For example, in single compartment embodiments, the packet may be made from one wall that is folded onto itself and sealed at the edges, or alternatively, two walls that are sealed together at the edges. In multiple compartment embodiments, the article and/or packet may be made from one or more films such that any given packet compartment may comprise walls made from a single film or multiple films having differing compositions. In one embodiment, a multi-compartment article and/or pouch comprises at least three walls: an outer upper wall; an outer lower wall; and a partitioning wall. The outer upper wall and the outer lower wall are generally opposing and form the exterior of the article and/or pouch. The partitioning wall is interior to the article and/or pouch and is secured to the generally opposing outer walls along a seal line. The partitioning wall separates the interior of the multi-compartment article and/or pouch into at least a first compartment and a second compartment.

In one embodiment, the article and/or pouch comprises a first and a second sealed compartment. The second compartment is in a generally superposed relationship with the first sealed compartment such that the second sealed compartment and the first sealed compartment share a partitioning wall interior to the article and/or pouch.

In one embodiment, the article and/or pouch comprising a first and a second compartment further comprises a third sealed compartment. The third sealed compartment is in a generally superposed relationship with the first sealed compartment such that the third sealed compartment and the first sealed compartment share a partitioning wall interior to the article and/or pouch.

In some embodiments, the first composition and the second composition are selected from one of the following combinations: liquid, liquid; liquid, powder; powder, powder; liquid, gel; liquid, paste; powder, gel; powder; paste; gel; paste; gel, gel; paste, paste.

In some embodiments, the first, second and third compositions are selected from one of the following combinations: solid, liquid, liquid and liquid, liquid, liquid. Other combinations may include gels or pastes in similar combinations.

In one embodiment, the single compartment or plurality of sealed compartments contains a composition. The plurality of compartments may each contain the same or a different composition. The composition is selected from a liquid, solid or combination thereof.

In one embodiment, the composition may be selected from the group of liquid light duty and liquid heavy duty liquid detergent compositions, powdered detergent compositions, dish detergent for hand washing and/or machine washing; hard surface cleaning compositions, fabric enhancers, detergent gels commonly used for laundry, and bleach and laundry additives, shampoos, and body washes.

The formed articles and/or pouches may then be cut by a cutting device. Cutting can be accomplished using any known method. It may be preferred that the cutting is also done in continuous manner, and preferably with constant speed and preferably while in horizontal position. The cutting device can, for example, be a sharp item, or a hot item, or a laser, whereby in the latter cases, the hot item or laser ‘burns’ through the film/sealing area.

The different compartments of a multi-compartment pouches may be made together in a side-by-side style wherein the resulting, conjoined pouches may or may not be separated by cutting. Alternatively, the compartments can be made separately.

In some embodiments, articles and/or pouches may be made according to a process comprising the steps of: a) forming a first compartment (as described above); b) forming a recess within some or all of the closed compartment formed in step (a), to generate a second molded compartment superposed above the first compartment; c) filling and closing the second compartments by means of a third film; d) sealing the first, second and third films; and e) cutting the films to produce a multi-compartment article and/or pouch. The recess formed in step (b) may be achieved by applying a vacuum to the compartment prepared in step (a).

In some embodiments, second, and/or third compartment(s) can be made in a separate step and then combined with the first compartment as described in European Patent Application Number 08101442.5 or WO 2009/152031.

In some embodiments, articles and/or pouches may be made according to a process comprising the steps of: a) forming a first compartment, optionally using heat and/or vacuum, using a first film on a first forming machine; b) filling the first compartment with a first composition; c) on a second forming machine, deforming a second film, optionally using heat and vacuum, to make a second and optionally third molded compartment; d) filling the second and optionally third compartments; e) sealing the second and optionally third compartment using a third film; f) placing the sealed second and optionally third compartments onto the first compartment; g) sealing the first, second and optionally third compartments; and h) cutting the films to produce a multi-compartment article and/or pouch.

The first and second forming machines may be selected based on their suitability to perform the above process. In some embodiments, the first forming machine is preferably a horizontal forming machine, and the second forming machine is preferably a rotary drum forming machine, preferably located above the first forming machine.

It should be understood that by the use of appropriate feed stations, it may be possible to manufacture multi-compartment articles and/or pouches incorporating a number of different or distinctive compositions and/or different or distinctive liquid, gel or paste compositions.

In some embodiments, the film and/or article and/or pouch is sprayed or dusted with a suitable material, such as an active agent, a lubricant, an aversive agent, or mixtures thereof. In some embodiments, the film and/or pouch is printed upon, for example, with an ink and/or an active agent.

Article and/or Pouch Contents

The present articles and/or pouches may contain various compositions, for example household care compositions. A multi-compartment article and/or pouch may contain the same or different compositions in each separate compartment. The composition is proximal to the water-soluble film. The composition may be less than about 10 cm, or less than about 5 cm, or less than about 1 cm from the film. Typically, the composition is adjacent to the film or in contact with the film. The film may be in the form of a pouch or a compartment, containing the composition therein.

Multi-compartment articles and/or pouches may be utilized to keep compositions containing incompatible ingredients (e.g., bleach and enzymes) physically separated or partitioned from each other. It is believed that such partitioning may expand the useful life and/or decrease physical instability of such ingredients. Additionally or alternatively, such partitioning may provide aesthetic benefits as described in European Patent Application Number 09161692.0.

Non-limiting examples of useful compositions (e.g., household care compositions) include light duty and heavy duty liquid detergent compositions, hard surface cleaning compositions, detergent gels commonly used for laundry, bleach and laundry additives, fabric enhancer compositions (such as fabric softeners), shampoos, body washes, and other personal care compositions. Compositions of use in the present articles and/or pouches may take the form of a liquid, solid or a powder. Liquid compositions may comprise a solid. Solids may include powder or agglomerates, such as micro-capsules, beads, noodles or one or more pearlized balls or mixtures thereof. Such a solid element may provide a technical benefit, through the wash or as a pre-treat, delayed or sequential release component; additionally or alternatively, it may provide an aesthetic effect.

In embodiments wherein the composition housed in the sealed compartment comprises a liquid composition, the liquid composition can comprise from 10-30% water, for examples, from 10-25% water, from 10-20% water, from 10-18% water, from 10-17% water, or from 10-16% water. In embodiments, the liquid composition housed in the sealed compartment can comprise from 10-18% water. In embodiments, the liquid composition housed in the sealed compartment can comprise from 12-16% water.

For an article containing a liquid composition adjacent to or in contact with the film comprising the article, components of the liquid composition can migrate into the film, or components of the film can migrate into the liquid composition, or both. This migration of components can affect the film's composition and, accordingly, the film's physical properties. Without intending to be bound by theory, it is believed that the amount of water provided in a liquid composition in contact with a film affects migration of components between the film and the liquid composition. For compositions comprising a low amount of water, for example less than 10 wt. %, migration of components can be reduced, such that physical properties of the film are not significantly affected. For compositions comprising a high amount of water, for example greater than 30 wt. %, physical integrity of the film can be impacted due to increased solubility of the film in the liquid composition.

The disclosure further provides a method of improving the liquid release time of a thermoformed film of the disclosure, the method including contacting a thermoformed film having a draw ratio between 2.3 and 3.1 with a liquid detergent or solvent for at least two days; wherein the film comprises a polyvinyl alcohol resin and a plasticizer, wherein the plasticizer is provided in an amount in a range of about 5 to about 25 weight parts, based on 100 weight parts of total polyvinyl alcohol resin; wherein the liquid detergent or solvent comprises from about 10% to about 30% water, based on the total weight of the detergent or solvent.

The detergent or solvent is not particularly limited provided the water content is in a range of about 10 to about 30 wt. %, based on the total weight of the detergent or solvent, for example about 10-25 wt. %, about 10-20 wt. %, about 10-18 wt. %, about 10-17 wt. %, about 10-16 wt %, about 12 to 18 wt. %, or about 12 to 16 wt. %. The balance of the composition can include any liquid detergent ingredients, plasticizers, or other solvents disclosed herein. In embodiments, the detergent or solvent composition can include glycerin, propylene glycols, amines, alkyl ethers, alkyl ethoxylates, fatty acids, fatty alcohols, alkyl sulfonic acids, and combinations thereof.

### Test Liquid Laundry Detergent 1 (LLD1)

A suitable liquid laundry detergent for use as the composition contained within the pouch or packet of the films disclosed herein for testing has the following formulation. LLD1 contains approximately 10% total water, which includes water added to the formulation and water contained in the other raw materials.

| | Amount |
|---|---|
| Ingredient | (wt %) |
| Fatty Alcohol Ethoxylate, C₁₂₋₁₅; 7 moles of ethoxylation | 38.94% |
| Glycerin | 11.59% |
| Propylene Glycol | 7.56% |
| Deionized or Soft Water | 4.61% |
| Monoethanolamine | 3.53% |
| Linear Alkyl Sulfonic Acid (LAS) | 13.10% |
| Coconut Fatty Acid | 4.03% |
| Sodium Lauryl Ether Sulfate; 3 or 2 moles of ethoxylation | 10.08% |
| Polyetherimine ethoxylate | 2.52% |
| Enzymes, mixed | 4.03% |

### Test Liquid Laundry Detergent 2 (LLD2)

Another suitable liquid laundry detergent for use as the composition contained within the pouch or packet of the films disclosed herein for testing has the following formulation. LLD2 contains approximately 14% total water, which includes water added to the formulation and water contained in the other raw materials.

| | Amount |
|---|---|
| Ingredient | (wt %) |
| Fatty Alcohol Ethoxylate, C₁₂₋₁₅; 7 moles of ethoxylation | 38.33% |
| Glycerin | 11.41% |
| Propylene Glycol | 7.44% |
| Deionized or Soft Water | 10.08% |
| Monoethanolamine | 3.47% |
| Linear Alkyl Sulfonic Acid (LAS) | 12.90% |
| Coconut Fatty Acid | 3.97% |
| Sodium Lauryl Ether Sulfate; 3 or 2 moles of ethoxylation | 9.92% |
| Polyetherimine ethoxylate | 2.48% |

### Test Liquid Laundry Detergent 2 (LLD3)

Another suitable liquid laundry detergent for use as the composition contained within the pouch or packet of the films disclosed herein for testing has the following formulation. LLD3 contains approximately 4% total water, which includes water contained in the raw materials comprising the film.

| | Amount |
|---|---|
| Ingredient | (wt %) |
| Fatty Alcohol Ethoxylate, C₁₂₋₁₅; 7 moles of ethoxylation | 47.85% |
| Glycerin | 12.08% |
| Propylene Glycol | 7.88% |
| Deionized or Soft Water | 0.00% |
| Monoethanolamine | 3.68% |
| Linear Alkyl Sulfonic Acid (LAS) | 12.61% |
| Coconut Fatty Acid | 4.20% |
| Sodium Lauryl Ether Sulfate; 3 or 2 moles of ethoxylation | 9.09% |
| Polyetherimine ethoxylate | 2.63% |

### Liquid Release Test

A water-soluble film and/or pouch characterized by or to be tested for delayed solubility according to the Liquid Release Test is analyzed as follows using the following materials:
2 L beaker and 1.2 liters of deionized (DI) water
Water soluble pouch to be tested containing a liquid composition (typically 20-30 mL; record volume); the pouch is pre-conditioned for at least 24 hours at 23±1° C. and 50±4% Relative Humidity (RH)) or 38±1° C. and 80±4% Relative Humidity (RH)
Capsule/Frame Stand
Thermometer
Alligator clip or plastic grid
Timer

Before running the experiment, ensure that enough DI water is available to repeat the experiment five times, and ensure that the beaker is clean and dry. While this method is generally in line with ASTM D4332-13 on Standard Practice for Conditioning Containers, Packages or Packaging Components for Testing, the control of 50±2% RH is not maintained in this test method.

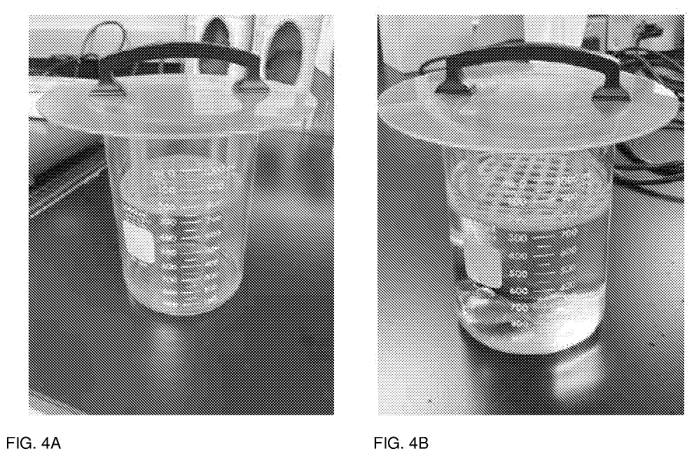

To set up for the test, carefully attach the water soluble pouch to an alligator clip attached to the frame stand. If the plastic grid is used, the water soluble pouch is placed in the empty beaker and the grid is placed on the beaker as shown in FIG. 4A. The orientation of the pouch in the beaker should be such that the natural buoyancy of the pouch, if any, is allowed (i.e. the side of the pouch that will float to the top should be placed towards the top). If the pouch is symmetrical, the orientation of the pouch generally would not matter.

Next, fill the 2 L beaker with 1200 milliliters of 20° C. DI water. If using the alligator clip set-up, lower the pouch into the water.

Be sure to fully submerge the pouch on all sides. Start a timer as soon as the pouch is lowered into the water, or the water is added to the beaker if using the plastic grid set-up.

Liquid content release is defined as the first visual evidence of the liquid leaving the submerged pouch.

Use the timer to record when the liquid content is released in to the surrounding water (Release Time) with a stopping point of 45 seconds.

A pass or fail grade will be given to each pouch. A pass grade is received if the soluble pouch retained its liquid for 30 seconds or longer. A fail grade is received if the soluble pouch did not retain its liquid for at least 30 seconds.

Repeat this process with new DI water and a new water soluble pouch five times for each film being tested. In line with general principles of testing and safety-related regulations, the test will be successful when at least 85% of the pouches tested do not release their content within minimum of 30 seconds, with a 90% confidence level.

A total of at least 15 pouches are tested for each film sample type unless reported otherwise. For each sample, report the conditioning conditions (e.g., days aged after pouch formation) and the thickness of the film tested.

### Air Release Test

A water-soluble film and/or pouch characterized by or to be tested for delayed solubility according to the Air Release Test is analyzed as follows using the following materials:
2 L beaker and 1.2 liters of deionized (DI) water
Water soluble pouch to be tested containing air; the pouch is pre-conditioned for at least 24 hours at 23±1° C. and 50±4% Relative Humidity (RH) or 38±1° C. and 80±4% Relative Humidity (RH)
Capsule/Frame Stand
Thermometer
Alligator clip or plastic grid
Timer

Before running the experiment, ensure that enough DI water is available to repeat the experiment five times, and ensure that the beaker is clean and dry.

To set up for the test, carefully attach the water soluble pouch to an alligator clip attached to the frame stand. If the plastic grid is used, the water soluble pouch is placed in the empty beaker and the grid is placed on the beaker as shown in FIG. 4A. The orientation of the pouch in the beaker should be such that the natural buoyancy of the pouch, if any, is allowed (i.e. the side of the pouch that will float to the top should be placed towards the top). If the pouch is symmetrical, the orientation of the pouch generally would not matter.

Next, fill the 2 L beaker with 1200 milliliters of 20° C. DI water. If using the alligator clip set-up, lower the pouch into the water.

Be sure to fully submerge the pouch on all sides. Start a timer as soon as the pouch is lowered into the water, or the water is added to the beaker if using the plastic grid set-up.

Air content release is defined as the first visual evidence of air leaving the submerged pouch.

Use the timer to record when air is released in to the surrounding water (Release Time) with a stopping point of 45 seconds.

A pass or fail grade will be given to each pouch. A pass grade is received if bubbles were not visible for 30 seconds or longer. A fail grade is received if bubbles were visible within 30 seconds. As described herein, the liquid release time of a thermoformed film can be improved by exposing the thermoformed film to a water-containing detergent or solvent. The liquid release time is generally measured at time T=24 hours and longer. Thus, the air release time (ART) can be considered the release time of the pouch at T=0, prior to the liquid composition of the pouch acting on the thermoformed film.

Repeat this process with new DI water and a new water soluble pouch five times for each film being tested. In line with general principles of testing and safety-related regulations, the test will be successful when at least 85% of the pouches tested do not release their content within minimum of 30 seconds, with a 90% confidence level.

References to liquid release times herein that are measured “in accordance with the Liquid Release Test” are tested with LLD2 having approximately 14 wt % water, unless indicated otherwise.

### Residue Test

This method can be used to assess film residue quantitatively. Pouches containing a liquid composition, such as a liquid laundry detergent (LLD), are collected from conditioning environment (38° C., 80% relative humidity (RH)) after a predetermined storage time. Pouches described herein were conditioned for 63 days in contact with LLD3 (4% water LLD). The pouches are cut open and the LLD is drained into a waste container. The detergent is completely removed from the film by wiping with Kim wipes. ATR spectra (n=3) of the inside of the capsule are collected. Each sample will be tested using a weigh boat and espresso brown cotton fabric cut into 54 mm circles. The weight of the weigh boat is measured and recorded, the cleaned film is weighed and recorded, and the dry weight of the fabric circle is weighed and recorded. A 1000 mL beaker is filled with 800 mL of 10° C.±1° C. tap water, a stir bar is added, and the beaker placed on top of a hot plate. The RPM of the hot plate is set to 550. The pouch is cut into approximately 4 equal pieces. All four pieces are dropped into the beaker and a timer is started as soon as the pouch pieces touch the water.

A vacuum flask is fitted with a rubber collar, Buchner funnel and vacuum pump. The fabric circle is placed inside of the Buchner funnel such that all of the holes of the funnel are covered. DI water is used to wet and stabilize the edges of the fabric. After the pouch pieces have been in the water for around 14 minutes and 45 seconds, the vacuum pump is started. As the timer hits 15 minutes, stirring is stopped and the liquor from the beaker is poured directly in the center of the fabric and funnel at a rate that does not displace the fabric. After all the liquor is filtered, the beaker and stir bar are inspected for visible residue. DI water from a squirt bottle is sprayed down the sides of the beaker and stir bar, the beaker is swirled several times, and the water poured into the Buchner funnel. The vacuum pump is allowed to run to pull out as much water as possible. Once the vacuum pump is switched off, tweezers are used to pull up one edge of the fabric followed by another edge; the two edges are pinched together in the tweezers and the fabric is transferred to the weigh boat. The sample is allowed to dry for at least 6 hours minimum. After the sample has dried, the weight of the weigh boat, fabric and film is taken as the final weight and the original weight of the weigh boat and fabric are subtracted from the final weight to get the weight of the film residue. The percent residue is calculated as follows: % Residue=(Residue weight/film initial weight)*100. A correction factor of 0.02 is added to the Residue result to account for any fabric loss during the filter process.

A pass or fail grade is given for each pouch. Unless defined otherwise, references to results of the Residue Test are to the % Residue after 63 days of storage in contact with LLD3. For the pouches described herein, a pass grade is given if % Residue after 63 days of storage in contact with LLD3 is less than 9%, and a fail grade is given if % Residue after 63 days of storage in contact with LLD3 is at least 9%. In embodiments, films according to the disclosure have no more than 10% Residue after 84 days of storage in contact with LLD3.

### Transmission Test

This test method can measure transmission, haze and clarity of a film using BYK Haze-Gard I or equivalent with BYK smart-chart software. The absorption and scattering behavior of the film specimen will determine how much light will pass through and how objects will appear through the transparent product.

Total Transmittance is the ratio of transmitted light to the incident light. It is influenced by the absorption and reflection properties. Depending on the angular distribution of the diffused portion, a transparent film will appear differently. Haze is the percentage of light which in passing through deviates from the incident beam greater than 2.5 degrees on the average. It produces a loss of contrast. Clarity is the see-through quality that is determined in an angle range smaller than 2.5 degrees.

BYK Calibration Standard Serial #1306881 is used if calibration is needed. Film can be conditioned but does not need to be. If the film is conditioned, the conditioning parameters are recorded. Review the film sample testing area and remove any soil, fingerprints, and abrasions of any kind. The film sample is placed over the top of the smaller, tapered ring of the holder. Then place the larger ring onto the outside of the smaller ring until the film is wrinkle-free and smooth for a haze reading. Any imperfections of the film should be minimized as they can affect how the light transmits through the sample.

Place the film specimen at the appropriate port. If any of the measuring modes are Transmission or Haze, start at the Haze port. Only start at the Clarity port for clarity only readings. Hit the measurement button and do not move or shift the sample while the indication lamp is flashing. Haze readings are distance-dependent, and the film should be flush against the haze port opening.

Take at least three measurements per sample, moving the sample around in the film holder before each reading. The film can be uniaxially stretched prior to testing. Films of the disclosure advantageously demonstrate a change in transmission value of less than 20%, less than 15%, less than 10%, or less than 5% after stretching by a stretch factor of 3 (i.e., 3 times the original length), relative to the transmission value of the film in its unstretched state.

### Dynamic Mechanical Analysis

DMA was performed using a Discover DMA 850 or equivalent with the TIROS v 5.4 software. A water-soluble film to be tested can be flat, non-thermoformed films, thermoformed films without exposure to liquid laundry detergent, and thermoformed films after exposure to liquid laundry detergent. The films are conditioned and/or stored in contact with liquid laundry detergent at 23° C., 50% RH or 38° C., 80% RH for at least 24 hours.

Experiment 1: Standard temperature ramp under constant frequency and amplitude. Starting from −50° C., the temperature was increased at a rate of 5° C./min to 140° C. A 10 hz frequency and 10 μm amplitude were used with a preload force of 0.1 N.

Experiment 2: Stress relaxation analysis. The temperature is equilibrated to 22° C. The film is strained to 200% elongation and held for 5 minutes. The initial stress and the stress after relaxation was monitored. The stress was released and the film recovery was monitored for 15 minutes.

DMA thermograms showing storage modulus, loss modulus, tan delta, length, and glass transition temperatures were collected.

Various aspects of the articles and methods are described below using numbered paragraphs.

### Aspect A

A1. A thermoformed article comprising a film thermoformed to be in the form of a pouch defining an interior pouch volume, the film comprising a mixture of a polyvinyl alcohol resin and a plasticizer, wherein the plasticizer is provided in an amount in a range of about 5 to about 30 weight parts, based on 100 weight parts of total polyvinyl alcohol resin (PHR);

wherein the thermoformed film in the form of a pouch defining an interior pouch volume is characterized by a draw ratio in a range of about 2.3 to about 2.9; the article is characterized by a release time of at least 30 seconds when formed into a sealed packet and tested in accordance with the Liquid Release Test; and the article is characterized by a residue value of at most 9%, as determined by the Residue Test.

A2. The article of A1, wherein the polyvinyl alcohol resin comprises:

a first polyvinyl alcohol-co-maleate polymer provided in an amount in a range of about 50 wt. % to about 90 wt. %, based on the total weight of polyvinyl alcohol polymers, and

a second polyvinyl alcohol-co-maleate polymer provided in an amount in a range of about 10 wt. % to about 50 wt. %, based on the total weight of polyvinyl alcohol polymers;

wherein the first and second polyvinyl alcohol-co-maleate copolymers differ in degree of maleate modification, viscosity, degree of hydrolysis, or a combination thereof.

A3. The article of A2, wherein the first polyvinyl alcohol-co-maleate polymer comprises a maleate monomer unit derived from a member selected from the group of maleic acid, monoalkyl maleate, dialkyl maleate, maleic anhydride, and a combination thereof.

A4. The article of A3, wherein the maleate monomer unit is provided in the first polyvinyl alcohol-co-maleate polymer in an amount in a range of about 1 mol % to about 3 mol %, based on the total moles of monomer units.

A5. The article of any one of claims A2 to A4, wherein the first polyvinyl alcohol-co-maleate polymer has a viscosity in a range of about 18 to about 30 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

A6. The article of any one of claims A2 to A5, wherein the second polyvinyl alcohol-co-maleate polymer comprises a maleate monomer unit derived from a member selected from the group of maleic acid, monoalkyl maleate, dialkyl maleate, maleic anhydride, and a combination thereof.

A7. The article of A6, wherein the maleate monomer unit is provided in the second polyvinyl alcohol-co-maleate polymer in an amount in a range of about 3 mol % to about 5 mol %, based on the total moles of monomer units.

A8. The article of any one A2 to A7, wherein the second polyvinyl alcohol-co-maleate polymer has a viscosity in a range of about 10 to about 20 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

A9. The article of any one of A1 to A8, wherein the plasticizer is selected from the group of sorbitol, glycerol, propylene glycol, 2-methyl-1,3-propanediol, trimethylolpropane, dipropylene glycol, and combinations thereof.

A10. The article of A9, wherein the plasticizer comprises sorbitol and glycerol.

A11. The article of any one of A2 to A10, wherein the first polyvinyl alcohol-co-maleate polymer is provided in an amount in a range of about 60 wt. % to about 80 wt. %, based on the total weight of polyvinyl alcohol polymers and the second polyvinyl alcohol-co-maleate polymer makes up the balance of polyvinyl alcohol polymers.

A12. The article of any one of A1 to A11, wherein the mixture further comprises a polyvinyl alcohol polymer selected from a polyvinyl alcohol homopolymer, a polyvinyl alcohol copolymer, and a combination thereof.

A13. The article of any one of A1 to A12, wherein the mixture further comprises a polymer selected from a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing.

A14. The article of any one of A1 to A13, wherein the mixture further comprises one or more components selected from a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.

A15. The article of any one of A1 to A14, wherein the plasticizer is provided in an amount in a range of about 5 to about 25 PHR, about 10 to about 25 PHR, about 15 to about 25 PHR, or about 18 to about 23 PHR.

### Aspect B

B1. A unit dose article comprising a sealed compartment and a composition housed in the sealed compartment, wherein the unit dose article comprises:

(a) a first film thermoformed in the form of a pouch defining an interior pouch volume, the pouch having an opening; and

(b) a second film sealed to the first film at the opening to create the sealed compartment, wherein the first film comprises a mixture of a polyvinyl alcohol resin and a plasticizer, wherein the plasticizer is provided in an amount in a range of about 5 to about 30 weight parts, based on 100 weight parts of total polyvinyl alcohol resin; and

wherein the first film thermoformed in the form of a pouch defining an interior pouch volume is characterized by a draw ratio in a range of about 2.3 to about 3.1; the first film is characterized by a release time of at least 30 seconds when formed into a sealed packet and tested in accordance with the Liquid Release Test, and the first film is characterized by a residue value of at most 9%, as determined by the Residue Test.

B2. The unit dose article of B1, wherein the second film comprises a mixture of a polyvinyl alcohol resin and a plasticizer, wherein the plasticizer is provided in an amount in a range of about 5 to about 50 weight parts, based on 100 weight parts of total polyvinyl alcohol resin.

B3. The unit dose article of B1 or B2, wherein the polyvinyl alcohol resin of the first film and the second film comprises a mixture of a first polyvinyl alcohol-co-maleate polymer and a second polyvinyl alcohol-co-maleate polymer,

wherein the first polyvinyl alcohol-co-maleate polymer is provided in an amount in a range of about 50 wt. % to about 90 wt. %, based on the total weight of polyvinyl alcohol polymers in the film, and the second polyvinyl alcohol-co-maleate polymer is provided in an amount in a range of about 10 wt. % to about 50 wt. %, based on the total weight of polyvinyl alcohol polymers in the film;

wherein the first and second polyvinyl alcohol-co-maleate copolymers differ in degree of maleate modification, viscosity, degree of hydrolysis, or a combination thereof.

B4. The unit dose article of any one of B1 to B3, wherein the composition housed in the sealed compartment comprises a liquid composition.

B5. The unit dose article of B4, wherein the liquid composition comprises from 10-30% water, about 10-25% water, about 10-20% water, about 10-18% water, about 10-17% water, or about 10-16% water, based on the total weight of the liquid composition.

B6. The unit dose article of any one of B1 to B5, wherein the second film comprises a polyvinyl alcohol homopolymer, an anionic polyvinyl alcohol copolymer, or a combination thereof.

B7. The unit dose article of B6, wherein the anionic polyvinyl alcohol copolymer is selected from sulfonated and carboxylated anionic polyvinyl alcohol copolymers.

B8. The unit dose article of B7, wherein the carboxylated anionic polyvinyl alcohol copolymer comprises a carboxylate monomer unit derived from a monomer selected from an acrylate, a methacrylate, a maleate, and a mixture thereof.

B9. The unit dose article of any one of B1 to B8, wherein plasticizer is provided in the first film in an amount in a range of about 5 to about 25 weight parts, based on 100 weight parts of total polyvinyl alcohol polymers in the first film.

B10. The unit dose article of any one of B1 to B9, wherein plasticizer is provided in the second film in an amount in a range of about 5 to about 30 or about 5 to about 25 weight parts, based on 100 weight parts of total polyvinyl alcohol polymers in the second film.

B11. The unit does article of any one of B1 to B9, wherein plasticizer is provided in the second film in an amount in a range of about 25 to about 50 weight parts, based on 100 weight parts of total polyvinyl alcohol polymers in the second film.

B12. The unit dose article of any one of B3 to B11, wherein the first polyvinyl alcohol-co-maleate polymer comprises a maleate monomer unit derived from a member selected from the group of maleic acid, monoalkyl maleate, dialkyl maleate, maleic anhydride, and a combination thereof.

B13. The unit dose article of B12, wherein the maleate monomer unit is provided in the first polyvinyl alcohol-co-maleate polymer in an amount in a range of about 1 mol % to about 3 mol %, based on the total moles of monomer units.

B14. The unit dose article of any one of B3 to B13, wherein the first polyvinyl alcohol-co-maleate polymer has a viscosity in a range of about 18 to about 30 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

B15. The unit dose article of any one of B3 to B14, wherein the second polyvinyl alcohol-co-maleate polymer comprises a maleate monomer unit derived from a member selected from the group of maleic acid, monoalkyl maleate, dialkyl maleate, maleic anhydride, and a combination thereof.

B16. The unit dose article of B15, wherein the maleate monomer unit is provided in the second polyvinyl alcohol-co-maleate polymer in an amount in a range of about 3 mol % to about 5 mol %, based on the total moles of monomer units.

B17. The unit dose article of any one of B3 to B16, wherein the second polyvinyl alcohol-co-maleate polymer has a viscosity in a range of about 10 to about 20 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

B18. The unit dose article of any one of B1 to B17, wherein the plasticizer is provided in an amount in a range of about 10 to about 30 weight parts, or about 10 to about 25 weight parts, based on 100 weight parts of total polyvinyl alcohol polymers.

B19. The unit dose article of any one of B1 to B18, wherein the plasticizer is selected from sorbitol, glycerol, propylene glycol, 2-methyl-1,3-propanediol, trimethylolpropane, dipropylene glycol, and a combination thereof.

B20. The unit dose article of B19, wherein the plasticizer comprises sorbitol and glycerol.

B21. The unit dose article of any one of B3 to B20, wherein the first polyvinyl alcohol-co-maleate polymer is provided in an amount in a range of about 60 wt. % to about 80 wt. %, based on the total weight of polyvinyl alcohol polymers and the second polyvinyl alcohol-co-maleate polymer makes up the balance of polyvinyl alcohol polymers.

B22. The unit dose article of any one of B1 to B21, wherein the first film, second film, or both further comprises a polymer selected from a polyvinyl alcohol, an anionic polyvinyl alcohol copolymer, a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing.

B23. The unit dose article of any one of B1 to B22, wherein the first film, second film, or both further comprises one or more components selected from the group consisting of a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.

B24. The unit dose article of any one of B3 to B23, wherein the first film comprises the first polyvinyl alcohol-co-maleate polymer in an amount of about 70 wt. %, based on the total weight of the polyvinyl alcohol polymers, wherein the first polyvinyl alcohol-co-maleate polymer comprises a maleate monomer unit in an amount in a range of about 1.5 mol % to about 2.0 mol % based on the total monomer units and the first polyvinyl alcohol-co-maleate polymer has a viscosity in a range of about 21 cP to about 26 cP.

B25. The unit dose article of any one of B3 to B24, wherein the first film comprises the second polyvinyl alcohol-co-maleate polymer in an amount of about 30 wt. %, based on the total weight of the polyvinyl alcohol polymers, wherein the second polyvinyl alcohol-co-maleate polymer comprises a maleate monomer unit in an amount in a range of about 3.8 mol % to about 4.2 mol % based on the total monomer units and the second polyvinyl alcohol-co-maleate polymer has a viscosity in a range of about 14 cP to about 19 cP.

B26, The unit dose article of any one of B3 to B25, wherein

(a) the first film comprises
the first polyvinyl alcohol-co-maleate polymer in an amount of about 70 wt. %, based on the total weight of the polyvinyl alcohol polymers, wherein the first polyvinyl alcohol-co-maleate polymer comprises a maleate monomer unit in an amount in a range of about 1.5 mol % to about 2.0 mol % based on the total monomer units and the first polyvinyl alcohol-co-maleate polymer has a viscosity in a range of about 21 cP to about 26 cP;
the second polyvinyl alcohol-co-maleate polymer in an amount of about 30 wt. %, based on the total weight of the polyvinyl alcohol polymers, wherein the second polyvinyl alcohol-co-maleate polymer comprises a maleate monomer unit in an amount in a range of about 3.8 mol % to about 4.2 mol % based on the total monomer units and the second polyvinyl alcohol-co-maleate polymer has a viscosity in a range of about 14 cP to about 19 cP; and
plasticizer provided in an amount in a range of about 18 to about 23 weight parts, based on 100 weight parts of total polyvinyl alcohol polymers in the first film, wherein the plasticizer consists of sorbitol and glycerin;

(b) the second film comprises
an anionic polyvinyl alcohol copolymer, wherein the anionic polyvinyl alcohol copolymer is a carboxylated anionic polyvinyl alcohol copolymer, wherein the carboxylate group comprising the carboxylated anionic polyvinyl alcohol copolymer comprises methyl acrylate, and
plasticizer provided in an amount in a range of about 35 to about 45 weight parts, based on 100 weight parts of total polyvinyl alcohol in the second film;

(c) the unit dose article comprises a liquid laundry detergent housed in the sealed compartment; and

(d) the unit dose article is characterized by a draw ratio of at least 2.3, a release time of at least 30 seconds when tested in accordance with the Liquid Release Test, and a residue value of at most 9%, as determined by the Residue Test.

### Aspect C

C1. A method of improving the liquid release time of a thermoformed film, the method comprising:

contacting a thermoformed film having a draw ratio between 2.3 and 3.1 with a liquid detergent or solvent for at least two days;

wherein the film comprises a polyvinyl alcohol resin and a plasticizer, wherein the plasticizer is provided in an amount in a range of about 5 to about 30 weight parts, based on 100 weight parts of total polyvinyl alcohol resin;

wherein the liquid detergent or solvent comprises from about 10% to about 30% water, based on the total weight of the detergent or solvent.

C2. The method of C2, wherein the polyvinyl alcohol resin comprises:

a first polyvinyl alcohol-co-maleate polymer provided in an amount in a range of about 50 wt. % to about 90 wt. %, based on the total weight of polyvinyl alcohol polymers, and

a second polyvinyl alcohol-co-maleate polymer provided in an amount in a range of about 10 wt. % to about 50 wt. %, based on the total weight of polyvinyl alcohol polymers;

wherein the first and second polyvinyl alcohol-co-maleate copolymers differ in degree of maleate modification, viscosity, degree of hydrolysis, or a combination thereof.

C3. The method of C2, wherein the first polyvinyl alcohol-co-maleate polymer comprises a maleate monomer unit derived from a member selected from the group of maleic acid, monoalkyl maleate, dialkyl maleate, maleic anhydride, and a combination thereof.

C4. The method of C3, wherein the maleate monomer unit is provided in the first polyvinyl alcohol-co-maleate polymer in an amount in a range of about 1 mol % to about 3 mol %, based on the total moles of monomer units.

C5. The method of any one of C2 to C4, wherein the first polyvinyl alcohol-co-maleate polymer has a viscosity in a range of about 18 to about 30 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

C6. The method of any one of C2 to C5, wherein the second polyvinyl alcohol-co-maleate polymer comprises a maleate monomer unit derived from a member selected from the group of maleic acid, monoalkyl maleate, dialkyl maleate, maleic anhydride, and a combination thereof.

C7. The method of C6, wherein the maleate monomer unit is provided in the second polyvinyl alcohol-co-maleate polymer in an amount in a range of about 3 mol % to about 5 mol %, based on the total moles of monomer units.

C8. The method of any one of C2 to C7, wherein the second polyvinyl alcohol-co-maleate polymer has a viscosity in a range of about 10 to about 20 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

C9. The method of any one of C1 to C8, wherein the plasticizer is selected from the group of sorbitol, glycerol, propylene glycol, 2-methyl-1,3-propanediol, trimethylolpropane, dipropylene glycol, and combinations thereof.

C10. The method of C9, wherein the plasticizer comprises sorbitol and glycerol.

C11. The method of any one of C2 to C10, wherein the first polyvinyl alcohol-co-maleate polymer is provided in an amount in a range of about 60 wt. % to about 80 wt. %, based on the total weight of polyvinyl alcohol polymers and the second polyvinyl alcohol-co-maleate polymer makes up the balance of polyvinyl alcohol polymers.

C12. The method of any one of C1 to C11, wherein the mixture further comprises a polyvinyl alcohol polymer selected from a polyvinyl alcohol homopolymer, a polyvinyl alcohol copolymer, and a combination thereof.

C13. The method of any one of C1 to C12, wherein the mixture further comprises a polymer selected from a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing.

C14. The method of any one of C1 to C13, wherein the mixture further comprises one or more components selected from a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.

C15. The method of any one of C1 to C14, wherein the plasticizer is provided in an amount in a range of about 5 to about 25 weight parts, about 10 to about 25 weight parts, about 15 to about 25 weight parts, or about 18 to about 23 weight parts based on 100 weight parts of total polyvinyl alcohol resin.

C16. The method of any one of claims C1 to C15, wherein the liquid detergent or solvent comprises from about 10% to about 25% water, about 10 to about 20% water, about 10 to about 18% water, about 10 to about 17% water, or about 10 to about 16% water, based on the total weight of the detergent or solvent.

### Examples

Water-soluble films were thermoformed into pouches enclosing a liquid laundry detergent, conditioned at 23° C., 50% RH or 38° C., 80% RH and tested for liquid release, residue, DMA, and/or transmissibility in accordance with the test methods set forth herein. Films A-F were prepared according to the formulations shown in the table below.

| | | | Film A | Film B | Film C | Film D | Film E | Film F |
|---|---|---|---|---|---|---|---|---|
| Resin | | | | | | | | |
| | PVOH-co- | | | | | 100 | | |
| | methyl | | | | | phr | | |
| | acrylate | | | | | | | |
| | PVOH-co- | Nominal 1.5-2 mol % | 70 phr | 70 phr | 70 phr | | | |
| | maleate | modification; | | | | | | |
| | | nominal viscosity 21- | | | | | | |
| | | 26 cP; nominal DH | | | | | | |
| | | 89-93% | | | | | | |
| | PVOH-co- | Nominal 3.8-4.2 | 30 phr | 30 phr | 30 phr | | | |
| | maleate | mol % modification; | | | | | | |
| | | nominal viscosity 14- | | | | | | |
| | | 19 cP; nominal DH | | | | | | |
| | | 89-91% | | | | | | |
| | PVOH-co- | Nominal 1.7-2.4 | | | | | 100 | |
| | maleate | mol % modification; | | | | | phr | |
| | | nominal viscosity 28- | | | | | | |
| | | 32 cP; nominal DH | | | | | | |
| | | 94% | | | | | | |
| | PVOH-co- | | | | | | | 100 |
| | itaconate | | | | | | | phr |
| Plasticizer | | | 15-18 | 20-25 | 40-45 | 40-45 | 20-25 | 20-25 |
| | | | phr | phr | phr | phr | phr | phr |
| | Sorbitol | | Y | Y | Y | Y | N | Y |
| | Glycerol | | Y | Y | Y | Y | Y | Y |
| | DPG | | N | N | N | Y | N | N |
| | PEG200 | | N | N | N | N | Y | N |
| Antiblock | | | | | | | | |
| | Silica | | 0 | 0 | 0 | 1.5-2.5 | 0 | 0 |
| | | | | | | phr | | |
| | Starch | | 2-3 | 2-3 | 2-3 | 3-4 | 2-3 | 2-3 |
| | | | phr | phr | phr | phr | phr | phr |
| Other | | | 1-2 | 1-2 | 1-2 | 5-7 | 0.75-1 | 1-2 |
| | | | phr | phr | phr | phr | phr | phr |

The films were thermoformed into pouches having draw ratios between 2.1 and 3.6. The pouches were filled with liquid laundry detergent, and were characterized by DMA and tested for liquid release time and/or residue in accordance with the test methods described herein. Films were also uniaxially stretched up to a factor of 3 and the transmissibility of the film tested in accordance with the transmission test.

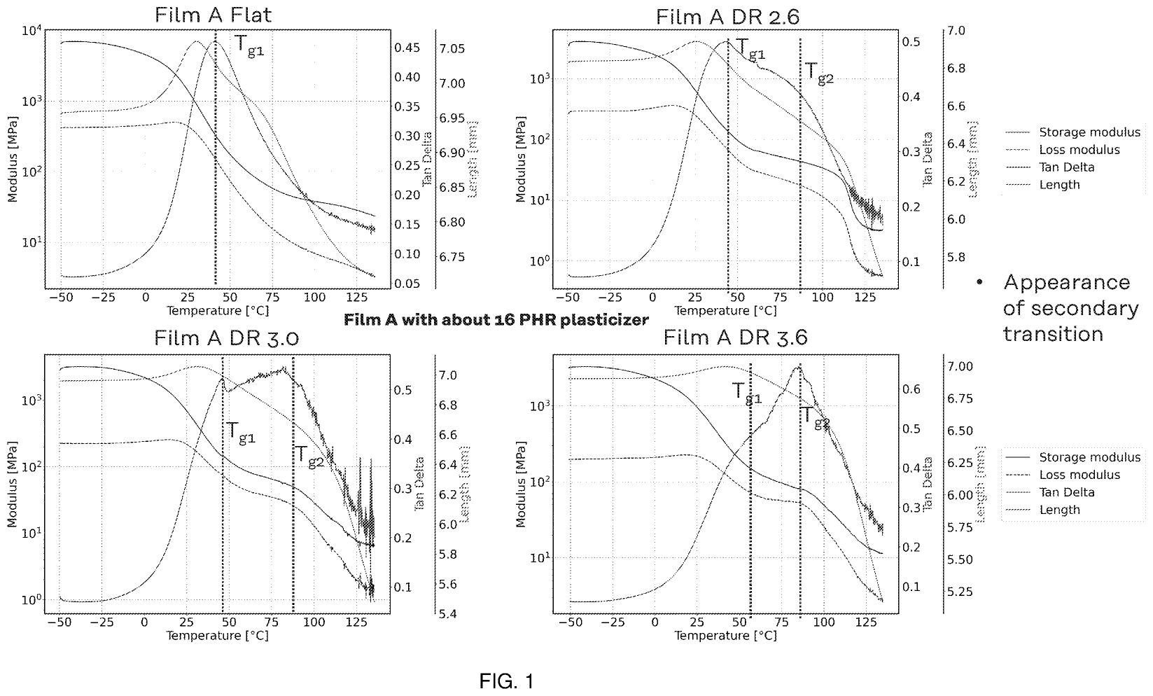

FIG. 1 shows DMA thermograms for Film A prior to thermoforming (flat film) and at draw ratios of 2.6, 2.0, and 3.6. The DMA thermograms for Film A demonstrate the appearance of a secondary glass transition temperature after thermoforming to a draw ratio of at least 2.6. Without intending to be bound by theory, it is believed that the appearance of the secondary glass transition temperature indicates the formation of an ordered, but not crystalline, phase in the film upon thermoforming. Upon exposure of this film to liquid laundry detergent for 1 week, the DMA thermogram (not shown) included only one glass transition temperature, consistent with the thermogram of the initial, flat, non-thermoformed film. Without intending to be bound by theory, it is believed that the plasticizer and/or organic solvents from the liquid laundry detergent were able to migrate into the film, relaxing the stress in the ordered phase, reverting the ordered phase back to an amorphous phase.

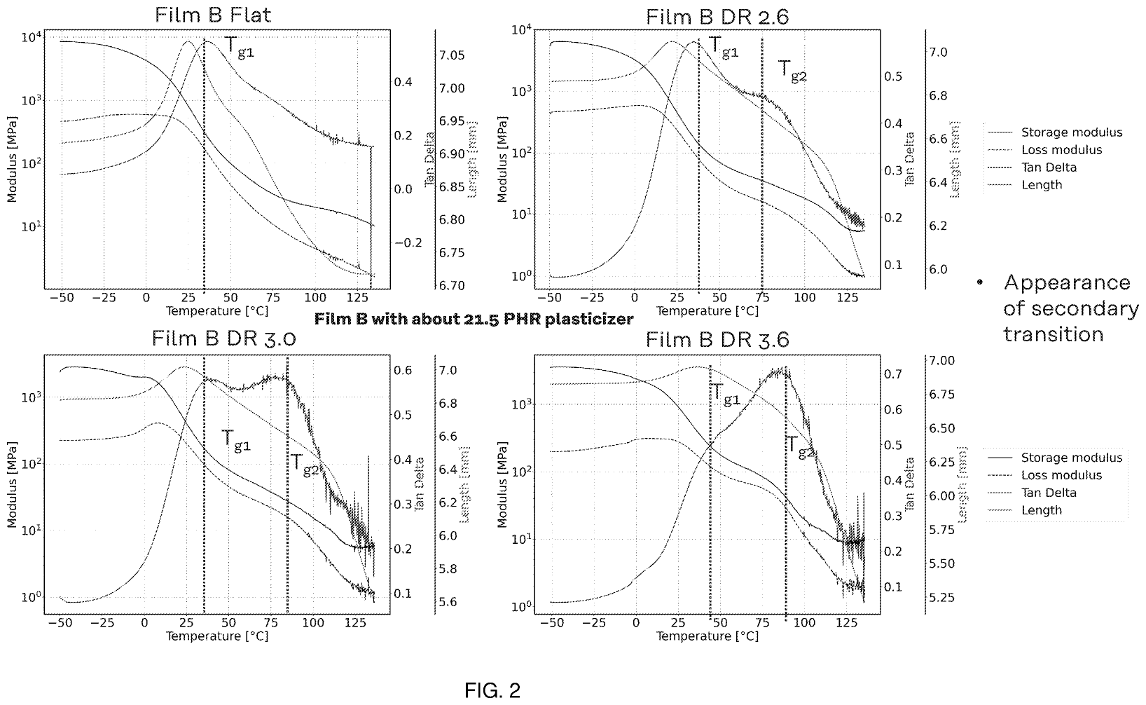

FIG. 2 shows DMA thermograms for Film B prior to thermoforming (flat film) and at draw ratios of 2.6, 2.0, and 3.6. The DMA thermograms for Film B demonstrate the appearance of a secondary glass transition temperature after thermoforming to a draw ratio of at least 2.6. Upon exposure of this film to liquid laundry detergent for 1 week, the DMA thermogram (not shown) included only one glass transition temperature, consistent with the thermogram of the initial, flat, non-thermoformed film.

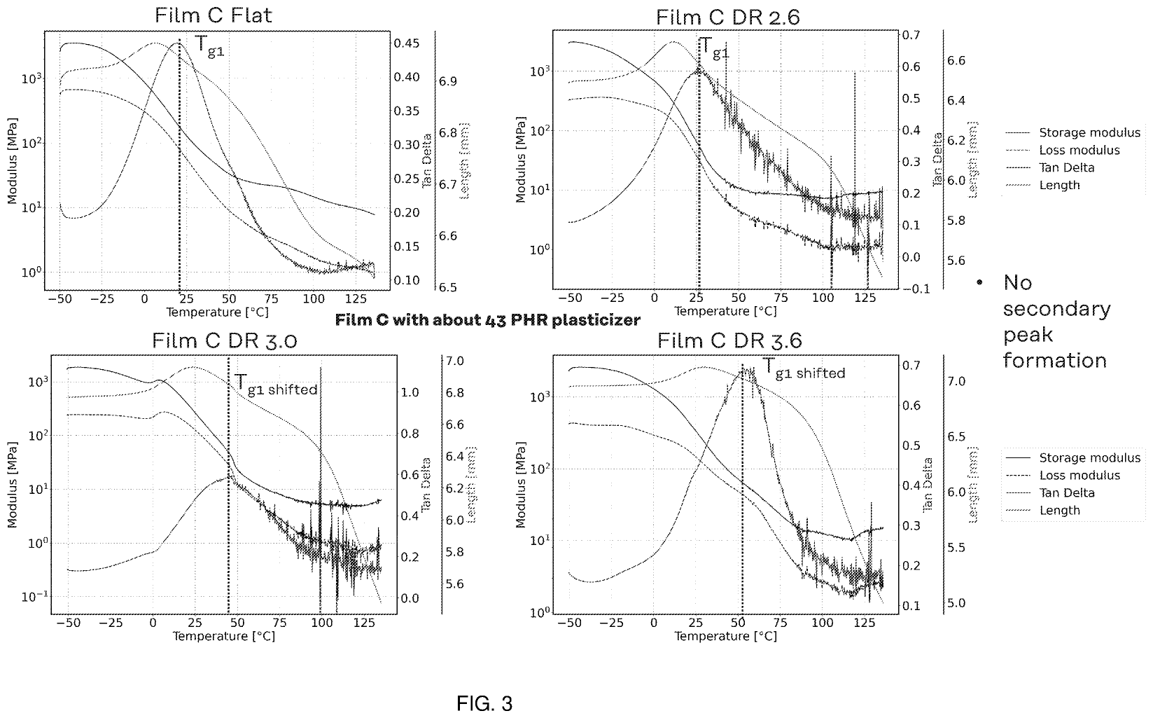

FIG. 3 shows DMA thermograms for Film C prior to thermoforming (flat film) and at draw ratios of 2.6, 2.0, and 3.6. The DMA thermograms for Film C did not demonstrate an appearance of a secondary glass transition temperature after thermoforming to a draw ratio of at least 2.6, but did demonstrate a shift in the glass transition temperature. Without intending to be bound by theory, it is believed that the lack of an appearance of the secondary glass transition temperature is a result of the increased (relative to Films A and B) plasticizer amount in the film.

Table 1, below, provides transmission data of various films at various stretch factors, prior to exposure to liquid laundry detergent.

TABLE 1

| | Film D | Film B | Film E | Film F |
|---|---|---|---|---|
| Stretch factor | transmission | transmission | transmission | transmission |
| 1.0 | 86.006 | 87.519 | 85.411 | 88.206 |
| 1.5 | 80.25 | 87.987 | 85.904 | 88.227 |
| 2.0 | 60.98 | 87.977 | 85.971 | 87.428 |
| 2.5 | 53.36 | 87.944 | 85.528 | 85.601 |
| 3.0 | 48.48 | 86.506 | 84.722 | 84.370 |
| Δ1.0 to 3.0 (%) | 43.6% | 1.2% | 0.8% | 4.3% |

A second set of water-soluble films was thermoformed into pouches and tested for air release, liquid release, and residue in accordance with the test methods set forth herein. Films A-D are described above. Films G and H are described in the table below.

| | | | Film G | | Film H | |
|---|---|---|---|---|---|---|
| Resin | PVOH-co- | Nominal 1.5-2 mol % | 70 | phr | | |
| | maleate | modification; nominal | | | | |
| | | viscosity 21-26 cP; | | | | |
| | | nominal DH 89-93% | | | | |
| | PVOH-co- | Nominal 3.8-4.2 mol % | 30 | phr | 100 | phr |
| | maleate | modification; nominal | | | | |
| | | viscosity 14-19 cP; | | | | |
| | | nominal DH 89-91% | | | | |
| | PVOH-co- | Nominal 1.7-2.4 mol % | | | | |
| | maleate | modification; nominal | | | | |
| | | viscosity 28-32 cP; | | | | |
| | | nominal DH 94% | | | | |
| Plasti- | | | 20-25 | phr | 25-30 | phr |
| cizer | Sorbitol | | Y | | Y | |
| | Glycerol | | Y | | Y | |
| | DPG | | N | | N | |
| | PEG200 | | N | | Y | |
| Anti- | Silica | | 1.5-2.5 | phr | 0 | |
| block | Starch | | 2-3 | phr | 2-3 | phr |
| Other | | | 1-2 | phr | 1-2 | phr |

The films were converted to pouches and evaluated for air release. Films were thermoformed to a draw ratio of 2.3, 2.9, or 3.3 and sealed with a second film having the same composition as the thermoformed film to form empty (i.e., air-filled) pouches. Sealed pouches were stored at 23° C./50% RH or 38° C./80% RH for 1, 7, 14, or 28 days and evaluated according to the Air Release Test described herein. The test films were relatively fresh films, approximately one month in age relative to the time of casting. Results are shown in Table 3.

TABLE 3

| | Film | | 23° C./50% RH | | | | 38° C./80% RH | | | |
|---|---|---|---|---|---|---|---|---|---|---|
| Film | Thickness | Draw | Days in Storage | | | | Days in Storage | | | |
| Type | (μm) | Ratio | 1 | 7 | 14 | 28 | 1 | 7 | 14 | 28 |
| Film A | 88 | 2.3 | P | P | P | P | P | P | P | P |
| Film A | 88 | 2.9 | F | F | F | F | F | F | P | P |
| Film A | 88 | 3.3 | F | F | F | F | F | F | P | P |
| Film B | 88 | 2.3 | P | P | P | P | P | P | P | P |
| Film B | 88 | 2.9 | F | F | F | F | F | F | P | P |
| Film B | 88 | 3.3 | F | F | F | F | F | F | F | P |
| Film C | 88 | 2.3 | P | P | P | P | P | P | P | P |
| Film C | 88 | 2.9 | F | F | F | F | F | P | P | P |
| Film C | 88 | 3.3 | F | F | F | F | F | P | P | P |
| Film D | 88 | 2.3 | P | P | P | P | P | P | P | P |
| Film D | 88 | 2.9 | F | F | F | F | P | P | P | P |
| Film D | 88 | 3.3 | F | F | F | F | F | F | F | F |
| Film G | 88 | 2.3 | P | P | P | P | P | P | P | P |
| Film G | 88 | 2.9 | F | F | F | F | P | P | P | P |
| Film G | 88 | 3.3 | F | F | F | F | F | F | F | F |

In general, air release performance of each film at each draw ratio was maintained or improved during storage at 23° C./50% RH or 38° C./80% RH. Furthermore, storing films at higher temperature and humidity conditions generally improved air release performance. In particular, films that were thermoformed to a draw ratio of 2.9 had failing grades for air release after being stored at 14 or 28 days at 23° C./50% RH but passing grades for air release after being stored for 14 or 28 days at 38° C./80% RH. Additionally, for films thermoformed to a draw ratio of 3.3, Films A, B, and C stored for 28 days at 38° C./80% RH had passing grades for air release, while all films stored for 28 days at 23° C./50% RH had failing grades for air release. Without intending to be bound by theory, it is believed that storing thermoformed films under high humidity conditions increases the migration of water into the films, facilitating chain relaxation of the polymers from the aligned, stressed conditions resulting from thermoforming and further plasticizing the films and improving their physical integrity. Thus, the ART data suggests that water is a necessary component for improved LRT behavior.

The films were also evaluated for liquid release after contact with LLD2 (˜14% water liquid laundry detergent). Films were thermoformed into pouches having draw ratios between 2.3 and 3.1 and filled with LLD2. The pouches were sealed with a second film having the same composition as the film comprising the pouch, and the sealed pouches were tested for liquid release after 1, 7, or 14 days of contact with the liquid laundry detergent while stored in a 23° C./50% RH environment according to the Liquid Release Test described herein. These test films were not relatively fresh films, and were approximately 6.5 months in age relative to the time of casting. Results are shown in Table 4.

TABLE 4

| Film | Film Thickness | | 23° C./50% RH | | |
|---|---|---|---|---|---|
| Type | (μm) | Draw Ratio | 1 day | 7 days | 14 days |
| Film A | 88 | 2.3 | P | P | P |
| Film A | 88 | 2.6 | P | P | P |
| Film A | 88 | 2.9 | P | P | P |
| Film A | 88 | 3.1 | F | P | F |
| Film B | 88 | 2.3 | P | P | P |
| Film B | 88 | 2.6 | P | P | P |
| Film B | 88 | 2.9 | F | P | P |
| Film B | 88 | 3.1 | F | F | F |
| Film C | 88 | 2.3 | P | P | P |
| Film C | 88 | 2.6 | P | P | P |
| Film C | 88 | 2.9 | P | P | P |
| Film C | 88 | 3.1 | F | F | F |
| Film D | 88 | 2.3 | P | P | P |
| Film D | 88 | 2.6 | P | P | P |
| Film D | 88 | 2.9 | P | P | P |
| Film D | 88 | 3.1 | F | F | P |
| Film G | 88 | 2.3 | P | P | P |
| Film G | 88 | 2.6 | P | P | P |
| Film G | 88 | 2.9 | P | P | P |
| Film G | 88 | 3.1 | F | P | P |
| Film H | 88 | 2.3 | P | P | |
| Film H | 88 | 2.6 | P | P | |
| Film H | 88 | 2.9 | F | F | |
| Film H | 88 | 3.1 | F | F | |

The results in Table 4 show that all films when thermoformed to a draw ratio of 2.3-2.6 passed the Liquid Release Test after just 1 day of contact with LLD3 (liquid laundry detergent containing ˜14% water). Furthermore, for films thermoformed to a draw ratio of 2.9, all films except Film H had a passing grade for liquid release after 7 and 14 days of contact with 14% water LLD, and all films except Films B and H had a passing grade for liquid release after just 1 day of contact with 14% water LLD.

The results in Tables 3 and 4 demonstrate the effects of contacting a thermoformed film with LLD. None of the films when thermoformed to a draw ratio of 2.9 had a passing grade for air release after up to 28 days of storage at 23° C./50% RH, while pouches comprising Films A, C, D, and G thermoformed to a draw ratio of 2.9 and stored at 23° C./50% RH in contact with 14% water LLD for just 1 day had passing grades for liquid release.

The films were also evaluated for liquid release after contact with LLD2 (liquid laundry detergent containing ˜4% water). Films were thermoformed into pouches having draw ratios between 2.3 and 3.3 and filled with LLD2. The pouches were sealed with a second film having the same composition as the film comprising the pouch, and sealed pouches were tested for liquid release after 1, 7, 14, or 28 days of contact with the liquid laundry detergent while stored in a 23° C./50% RH environment according to the Liquid Release Test described herein. These test films were relatively fresh films, approximately one month in age relative to the time of casting. Results are shown in Table 5.

TABLE 5

| | Film | | 23° C./50% RH | | | | 38° C./80% RH | | | |
|---|---|---|---|---|---|---|---|---|---|---|
| Film | Thickness | Draw | Days in Storage | | | | Days in Storage | | | |
| Type | (μm) | Ratio | 1 | 7 | 14 | 28 | 1 | 7 | 14 | 28 |
| Film A | 88 | 2.3 | P | P | P | P | P | | P | P |
| Film A | 88 | 2.9 | F | F | F | F | P | | P | P |
| Film A | 88 | 3.3 | F | F | F | F | F | | P | P |
| Film B | 88 | 2.3 | P | P | P | P | P | P | P | P |
| Film B | 88 | 2.9 | F | F | F | P | P | P | P | F |
| Film B | 88 | 3.3 | F | F | F | P | F | F | F | F |
| Film C | 88 | 2.3 | P | P | P | P | P | P | P | P |
| Film C | 88 | 2.9 | F | F | F | F | F | P | P | P |
| Film C | 88 | 3.3 | F | F | F | F | F | F | F | P |
| Film D | 88 | 2.3 | P | P | P | P | P | P | P | P |
| Film D | 88 | 2.9 | F | F | P | P | P | P | P | P |
| Film D | 88 | 3.3 | F | F | F | F | F | F | F | F |
| Film G | 88 | 2.3 | P | P | P | P | P | P | P | P |
| Film G | 88 | 2.9 | F | F | F | F | F | P | P | P |
| Film G | 88 | 3.3 | F | F | F | F | F | P | P | P |

The results in Table 5 demonstrate that the effects of contact with LLD containing ˜4% water are less pronounced than the effects of contact with LLD containing 14% water. In particular, films thermoformed to a draw ratio of 2.9 required at least 14 days of contact with 4% water LLD at 23° C./50% RH to achieve a passing grades for liquid release, but the same films required no more than 7 days of contact with 14% water LLD under the same storage conditions to achieve passing grades.

Films were also tested for residue after extended periods of contact with liquid laundry detergent. Films were thermoformed into pouches, and the pouches were filled with LLD2 (liquid laundry detergent containing ˜4% water), sealed with a second film having the same composition as the film comprising the pouch, and tested according to the Residue Test described herein. Upon initial pouch formation, these test films were relatively fresh, approximately one month in age relative to casting. Results of the residue test are shown in Table 6.

Table 6 also includes results of measuring the sorbitol content of the films after contact with liquid laundry detergent. Films A, B, C, D, and G, all of which comprise sorbitol as a plasticizer, were thermoformed into pouches, and the pouches were filled with LLD2 and sealed with a second film. After 7 days of contact with the liquid laundry detergent, the pouches were opened, the detergent was removed, and the sorbitol content of each film was measured by liquid chromatography. Table 6 lists the relative change in sorbitol content, compared to the initial sorbitol content, of each film after 7 days of contact with liquid laundry detergent.

TABLE 6

| | | | | Relative change in |
|---|---|---|---|---|
| Film | Film Thickness | | Residue | sorbitol content |
| Type | (μm) | Draw Ratio | Test | (7 days) |
| Film A | 88 | 2.3 | P | −98% |
| Film B | 88 | 2.3 | P | −90% |
| Film C | 88 | 2.3 | F | −97% |
| Film D | 88 | 2.3 | F | −96% |
| Film G | 88 | 2.3 | P | −94% |

The results of Table 6 show that films of the disclosure, Films A and B, demonstrate good residue values (<9%) at 63 days. Significantly, Film B, comprising about 20-25 parts plasticizer per 100 parts polyvinyl alcohol polymer in the film, demonstrated significantly better residue performance after 84 days contact with liquid laundry detergent compared to Films A, C, and D. Film G, which includes silica but is otherwise identical to Film B, demonstrated the best residue values at each measurement. Table 4 also shows a significant reduction in sorbitol content of each film after contact with liquid laundry detergent for 7 days. Without intending to be bound by theory, it is believed that components of the thermoformed film can migrate to the liquid composition contained in the pouch and vice versa, and that the presence of water in the liquid composition can facilitate this migration of components.

Because modifications and changes varied to fit particular operating requirements and environments will be apparent to those skilled in the art, the disclosure is not considered limited to the examples chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, and literature references cited in this specification are hereby incorporated herein by reference in their entirety. In case of conflict, the present description, including definitions, will control.

Throughout the specification, where the compounds, compositions, articles, methods, and processes are described as including components, steps, or materials, it is contemplated that the compositions, processes, or apparatus can also comprise, consist essentially of, or consist of, any combination of the recited components or materials, unless described otherwise.

1. A thermoformed article comprising a film thermoformed to be in the form of a pouch defining an interior pouch volume, the film comprising a mixture of a polyvinyl alcohol resin and a plasticizer, wherein the plasticizer is provided in an amount in a range of about 5 to about 30 weight parts, based on 100 weight parts of total polyvinyl alcohol resin;
wherein the thermoformed film in the form of a pouch defining an interior pouch volume is characterized by a draw ratio in a range of about 2.3 to about 2.9; the article is characterized by a release time of at least 30 seconds when formed into a sealed packet and tested in accordance with the Liquid Release Test; and the article is characterized by a residue value of at most 9%, as determined by the Residue Test.

2. The article of claim 1, wherein the polyvinyl alcohol resin comprises:
a first polyvinyl alcohol-co-maleate polymer provided in an amount in a range of about 50 wt. % to about 90 wt. %, based on the total weight of polyvinyl alcohol polymers, and
a second polyvinyl alcohol-co-maleate polymer provided in an amount in a range of about 10 wt. % to about 50 wt. %, based on the total weight of polyvinyl alcohol polymers;
wherein the first and second polyvinyl alcohol-co-maleate copolymers differ in degree of maleate modification, viscosity, degree of hydrolysis, or a combination thereof.

3. The article of claim 2, wherein the first polyvinyl alcohol-co-maleate polymer comprises a maleate monomer unit derived from a member selected from the group of maleic acid, monoalkyl maleate, dialkyl maleate, maleic anhydride, and a combination thereof.

4. The article of claim 3, wherein the maleate monomer unit is provided in the first polyvinyl alcohol-co-maleate polymer in an amount in a range of about 1 mol % to about 3 mol %, based on the total moles of monomer units.

5. The article of claim 2, wherein the first polyvinyl alcohol-co-maleate polymer has a viscosity in a range of about 18 to about 30 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

6. The article of claim 2, wherein the second polyvinyl alcohol-co-maleate polymer comprises a maleate monomer unit derived from a member selected from the group of maleic acid, monoalkyl maleate, dialkyl maleate, maleic anhydride, and a combination thereof.

7. The article of claim 6, wherein the maleate monomer unit is provided in the second polyvinyl alcohol-co-maleate polymer in an amount in a range of about 3 mol % to about 5 mol %, based on the total moles of monomer units.

8. The article of claim 2, wherein the second polyvinyl alcohol-co-maleate polymer has a viscosity in a range of about 10 to about 20 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

9. The article of claim 1, wherein the plasticizer is selected from the group of sorbitol, glycerol, propylene glycol, 2-methyl-1,3-propanediol, trimethylolpropane, dipropylene glycol, and combinations thereof.

10. The article of claim 9, wherein the plasticizer comprises sorbitol and glycerol.

11. The article of claim 2, wherein the first polyvinyl alcohol-co-maleate polymer is provided in an amount in a range of about 60 wt. % to about 80 wt. %, based on the total weight of polyvinyl alcohol polymers and the second polyvinyl alcohol-co-maleate polymer makes up the balance of polyvinyl alcohol polymers.

12. The article of claim 1, wherein the mixture further comprises a polyvinyl alcohol polymer selected from a polyvinyl alcohol homopolymer, a polyvinyl alcohol copolymer, and a combination thereof.

13. The article of claim 1, wherein the mixture further comprises a polymer selected from a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing.

14. The article of claim 1, wherein the mixture further comprises one or more components selected from a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.

15. A unit dose article comprising a sealed compartment and a composition housed in the sealed compartment, wherein the unit dose article comprises:
(a) a first film thermoformed in the form of a pouch defining an interior pouch volume, the pouch having an opening; and
(b) a second film sealed to the first film at the opening to create the sealed compartment,
wherein the first film comprises a mixture of a polyvinyl alcohol resin and a plasticizer, wherein the plasticizer is provided in an amount in a range of about 5 to about 30 weight parts, based on 100 weight parts of total polyvinyl alcohol resin; and
wherein the first film thermoformed in the form of a pouch defining an interior pouch volume is characterized by a draw ratio in a range of about 2.3 to about 2.9; the first film is characterized by a release time of at least 30 seconds when formed into a sealed packet and tested in accordance with the Liquid Release Test, and the first film is characterized by a residue value of at most 9%, as determined by the Residue Test.

16. The unit dose article of claim 15, wherein the second film comprises a mixture of a polyvinyl alcohol resin and a plasticizer, wherein the plasticizer is provided in an amount in a range of about 5 to about 50 weight parts, based on 100 weight parts of total polyvinyl alcohol resin.

17. The unit dose article of claim 15, wherein the polyvinyl alcohol resin of the first film and the second film comprises a mixture of a first polyvinyl alcohol-co-maleate polymer and a second polyvinyl alcohol-co-maleate polymer,
wherein the first polyvinyl alcohol-co-maleate polymer is provided in an amount in a range of about 50 wt. % to about 90 wt. %, based on the total weight of polyvinyl alcohol polymers in the film, and the second polyvinyl alcohol-co-maleate polymer is provided in an amount in a range of about 10 wt. % to about 50 wt. %, based on the total weight of polyvinyl alcohol polymers in the film;
wherein the first and second polyvinyl alcohol-co-maleate copolymers differ in degree of maleate modification, viscosity, degree of hydrolysis, or a combination thereof.

18. The unit dose article of claim 15, wherein the composition housed in the sealed compartment comprises a liquid composition.

19. The unit dose article of claim 18, wherein the liquid composition comprises from 10-30% water, based on the total weight of the liquid composition.

20. The unit dose article of claim 15, wherein the second film comprises a polyvinyl alcohol homopolymer, an anionic polyvinyl alcohol copolymer, or a combination thereof.

21. The unit dose article of claim 20, wherein the anionic polyvinyl alcohol copolymer is selected from sulfonated and carboxylated anionic polyvinyl alcohol copolymers.

22. The unit dose article of claim 21, wherein the carboxylated anionic polyvinyl alcohol copolymer comprises a carboxylate monomer unit derived from a monomer selected from an acrylate, a methacrylate, a maleate, and a mixture thereof.

23. The unit dose article of claim 15, wherein plasticizer is provided in the first film in an amount in a range of about 5 to about 25 weight parts, based on 100 weight parts of total polyvinyl alcohol polymers in the first film.

24. The unit dose article of claim 15, wherein plasticizer is provided in the second film in an amount in a range of about 5 to about 30 or about 5 to about 25 weight parts, based on 100 weight parts of total polyvinyl alcohol polymers in the second film.

25. The unit does article of claim 15, wherein plasticizer is provided in the second film in an amount in a range of about 25 to about 50 weight parts, based on 100 weight parts of total polyvinyl alcohol polymers in the second film.

26. The unit dose article of claim 17, wherein the first polyvinyl alcohol-co-maleate polymer comprises a maleate monomer unit derived from a member selected from the group of maleic acid, monoalkyl maleate, dialkyl maleate, maleic anhydride, and a combination thereof.

27. The unit dose article of claim 26, wherein the maleate monomer unit is provided in the first polyvinyl alcohol-co-maleate polymer in an amount in a range of about 1 mol % to about 3 mol %, based on the total moles of monomer units.

28. The unit dose article of claim 17, wherein the first polyvinyl alcohol-co-maleate polymer has a viscosity in a range of about 18 to about 30 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

29. The unit dose article of claim 17, wherein the second polyvinyl alcohol-co-maleate polymer comprises a maleate monomer unit derived from a member selected from the group of maleic acid, monoalkyl maleate, dialkyl maleate, maleic anhydride, and a combination thereof.

30. The unit dose article of claim 29, wherein the maleate monomer unit is provided in the second polyvinyl alcohol-co-maleate polymer in an amount in a range of about 3 mol % to about 5 mol %, based on the total moles of monomer units.

31. The unit dose article of claim 17, wherein the second polyvinyl alcohol-co-maleate polymer has a viscosity in a range of about 10 to about 20 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

32. The unit dose article of claim 15, wherein the plasticizer is provided in an amount in a range of about 10 to about 30 weight parts, based on 100 weight parts of total polyvinyl alcohol polymers.

33. The unit dose article of claim 15, wherein the plasticizer is selected from sorbitol, glycerol, propylene glycol, 2-methyl-1,3-propanediol, trimethylolpropane, dipropylene glycol, and a combination thereof.

34. The unit dose article of claim 33, wherein the plasticizer comprises sorbitol and glycerol.

35. The unit dose article of claim 17, wherein the first polyvinyl alcohol-co-maleate polymer is provided in an amount in a range of about 60 wt. % to about 80 wt. %, based on the total weight of polyvinyl alcohol polymers and the second polyvinyl alcohol-co-maleate polymer makes up the balance of polyvinyl alcohol polymers.

36. The unit dose article of claim 15, wherein the first film, second film, or both further comprises a polymer selected from a polyvinyl alcohol, an anionic polyvinyl alcohol copolymer, a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing.

37. The unit dose article of claim 15, wherein the first film, second film, or both further comprises one or more components selected from the group consisting of a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.

38. The unit dose article of claim 17, wherein the first film comprises the first polyvinyl alcohol-co-maleate polymer in an amount of about 70 wt. %, based on the total weight of the polyvinyl alcohol polymers, wherein the first polyvinyl alcohol-co-maleate polymer comprises a maleate monomer unit in an amount in a range of about 1.5 mol % to about 2.0 mol % based on the total monomer units and the first polyvinyl alcohol-co-maleate polymer has a viscosity in a range of about 21 cP to about 26 cP.

39. The unit dose article of claim 17, wherein the first film comprises the second polyvinyl alcohol-co-maleate polymer in an amount of about 30 wt. %, based on the total weight of the polyvinyl alcohol polymers, wherein the second polyvinyl alcohol-co-maleate polymer comprises a maleate monomer unit in an amount in a range of about 3.8 mol % to about 4.2 mol % based on the total monomer units and the second polyvinyl alcohol-co-maleate polymer has a viscosity in a range of about 14 cP to about 19 cP.

40. The unit dose article of claim 17, wherein
(a) the first film comprises
the first polyvinyl alcohol-co-maleate polymer in an amount of about 70 wt. %, based on the total weight of the polyvinyl alcohol polymers, wherein the first polyvinyl alcohol-co-maleate polymer comprises a maleate monomer unit in an amount in a range of about 1.5 mol % to about 2.0 mol % based on the total monomer units and the first polyvinyl alcohol-co-maleate polymer has a viscosity in a range of about 21 cP to about 26 cP;
the second polyvinyl alcohol-co-maleate polymer in an amount of about 30 wt. %, based on the total weight of the polyvinyl alcohol polymers, wherein the second polyvinyl alcohol-co-maleate polymer comprises a maleate monomer unit in an amount in a range of about 3.8 mol % to about 4.2 mol % based on the total monomer units and the second polyvinyl alcohol-co-maleate polymer has a viscosity in a range of about 14 cP to about 19 cP; and
plasticizer provided in an amount in a range of about 18 to about 23 weight parts, based on 100 weight parts of total polyvinyl alcohol polymers in the first film, wherein the plasticizer consists of sorbitol and glycerin;
(b) the second film comprises
an anionic polyvinyl alcohol copolymer, wherein the anionic polyvinyl alcohol copolymer is a carboxylated anionic polyvinyl alcohol copolymer, wherein the carboxylate group comprising the carboxylated anionic polyvinyl alcohol copolymer comprises methyl acrylate, and
plasticizer provided in an amount in a range of about 35 to about 45 weight parts, based on 100 weight parts of total polyvinyl alcohol in the second film;
(c) the unit dose article comprises a liquid laundry detergent housed in the sealed compartment; and
(d) the unit dose article is characterized by a draw ratio of at least 2.3, a release time of at least 30 seconds when tested in accordance with the Liquid Release Test, and a residue value of at most 9%, as determined by the Residue Test.

41. A method of improving the liquid release time of a thermoformed film, the method comprising:
contacting a thermoformed film having a draw ratio between 2.3 and 3.1 with a liquid detergent or solvent for at least two days;
wherein the film comprises a polyvinyl alcohol resin and a plasticizer, wherein the plasticizer is provided in an amount in a range of about 5 to about 30 weight parts, based on 100 weight parts of total polyvinyl alcohol resin;
wherein the liquid detergent or solvent comprises from about 10% to about 30% water, based on the total weight of the detergent or solvent.

42. The method of claim 41, wherein the polyvinyl alcohol resin comprises:
a first polyvinyl alcohol-co-maleate polymer provided in an amount in a range of about 50 wt. % to about 90 wt. %, based on the total weight of polyvinyl alcohol polymers, and
a second polyvinyl alcohol-co-maleate polymer provided in an amount in a range of about 10 wt. % to about 50 wt. %, based on the total weight of polyvinyl alcohol polymers;
wherein the first and second polyvinyl alcohol-co-maleate copolymers differ in degree of maleate modification, viscosity, degree of hydrolysis, or a combination thereof.

43. The method of claim 42, wherein the first polyvinyl alcohol-co-maleate polymer comprises a maleate monomer unit derived from a member selected from the group of maleic acid, monoalkyl maleate, dialkyl maleate, maleic anhydride, and a combination thereof.

44. The method of claim 43, wherein the maleate monomer unit is provided in the first polyvinyl alcohol-co-maleate polymer in an amount in a range of about 1 mol % to about 3 mol %, based on the total moles of monomer units.

45. The method of claim 42, wherein the first polyvinyl alcohol-co-maleate polymer has a viscosity in a range of about 18 to about 30 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

46. The method of claim 42, wherein the second polyvinyl alcohol-co-maleate polymer comprises a maleate monomer unit derived from a member selected from the group of maleic acid, monoalkyl maleate, dialkyl maleate, maleic anhydride, and a combination thereof.

47. The method of claim 46, wherein the maleate monomer unit is provided in the second polyvinyl alcohol-co-maleate polymer in an amount in a range of about 3 mol % to about 5 mol %, based on the total moles of monomer units.

48. The method of claim 42, wherein the second polyvinyl alcohol-co-maleate polymer has a viscosity in a range of about 10 to about 20 cP, as determined by measuring a freshly made solution of 4% aqueous polyvinyl alcohol solution at 20° C., using a Brookfield LV type viscometer with UL adapter, as described in British Standard EN ISO 15023-2:2006 Annex E Brookfield Test method.

49. The method of claim 41, wherein the plasticizer is selected from the group of sorbitol, glycerol, propylene glycol, 2-methyl-1,3-propanediol, trimethylolpropane, dipropylene glycol, and combinations thereof.

50. The method of claim 49, wherein the plasticizer comprises sorbitol and glycerol.

51. The method of claim 42, wherein the first polyvinyl alcohol-co-maleate polymer is provided in an amount in a range of about 60 wt. % to about 80 wt. %, based on the total weight of polyvinyl alcohol polymers and the second polyvinyl alcohol-co-maleate polymer makes up the balance of polyvinyl alcohol polymers.

52. The method of claim 41, wherein the mixture further comprises a polyvinyl alcohol polymer selected from a polyvinyl alcohol homopolymer, a polyvinyl alcohol copolymer, and a combination thereof.

53. The method of claim 41, wherein the mixture further comprises a polymer selected from a polyethyleneimine, a polyvinyl pyrrolidone, a polyalkylene oxide, a polyacrylamide, a cellulose ether, a cellulose ester, a cellulose amide, a polyvinyl acetate, a polyamide, a gelatin, a methylcellulose, a carboxymethylcellulose, a carboxymethyl cellulose salt, a dextrin, an ethylcellulose, a hydroxyethyl cellulose, a hydroxypropyl methylcellulose, a maltodextrin, a starch, a modified starch, guar gum, gum Acacia, xanthan gum, carrageenan, a polyacrylate, a polyacrylate salt, and a copolymer of any of the foregoing.

54. The method of claim 41, wherein the mixture further comprises one or more components selected from a surfactant, a plasticizer compatibilizer, a lubricant, a release agent, a filler, an extender, a cross-linking agent, an antiblocking agent, an antioxidant, a detackifying agent, an antifoam, a nanoparticle, a bleaching agent, an aversive agent, a surfactant, and a combination thereof.
